(19) United States
(12) Patent Application Publication
(10) Pub. No.: US 2025/0343487 A1
(43) Pub. Date: Nov. 6, 2025

(54) POWER CONVERSION DEVICE AND START-UP DEVICE FOR POWER CONVERSION DEVICE

(71) Applicant: SHANGHAI METAPWR ELECTRONICS CO., LTD, Shanghai (CN)

(72) Inventors: Da Jin, Shanghai (CN); Yahong Xiong, Shanghai (CN); Qinghua Su, Shanghai (CN)

(73) Assignee: SHANGHAI METAPWR ELECTRONICS CO., LTD, Shanghai (CN)

(21) Appl. No.: 19/198,152

(22) Filed: May 5, 2025

(30) Foreign Application Priority Data
May 3, 2024 (CN) 202410543172.7
Dec. 16, 2024 (CN) 202411853641.1

(51) Int. Cl. H02M 3/335; H02M 1/00; H02M 3/00

(52) U.S. Cl. CPC H02M 3/33576; H02M 1/0095; H02M 3/01

(57) ABSTRACT

A power conversion device includes an input end, an output end, a first switch bridge arm, a second switch bridge arm, a first flying capacitor, a second flying capacitor, an output capacitor, and a magnetic assembly. Through a winding mode of a transformer winding, the requirement that the ratio of the input voltage to the output voltage is 5:1 or even 8:1 can be met, and the winding mode of the transformer winding and the layout of the power devices are optimized, so that the loss is reduced, and the size is reduced.

### CROSS-REFERENCE TO RELATED APPLICATION

This application claims the priority benefit of China application serial no. CN 202410543172.7 filed on May. 3, 2024, and China application serial no. CN 202411853641.1 filed on Dec. 16, 2024. The entirety of each of the above-mentioned patent applications is hereby incorporated by reference herein and made a part of this specification.

### BACKGROUND

### Description of Related Art

With the development of artificial intelligence, the power requirements of an intelligent data processing chip, such as a GPU/CPU NPU and the like (collectively referred to as XPU) are higher and higher, so that the power of the server is greatly increased, the input voltage of the server gradually changes from 12V to 48V. And the working voltage of the XPU becomes lower and lower along with the progress of the process and gradually moves from 0.8V to 0. 65V. Therefore, the ratio of the input voltage to the output voltage becomes larger and larger, so that the two-stage step-down circuit architecture gradually becomes mainstream; and the two-stage step-down circuit architecture comprises a front-stage proportional converter and a rear-stage voltage regulator. In order to obtain high conversion efficiency of 48V input-to-0.65V output, the ratio of the input voltage to the output voltage of the proportional converter changes from 4:1 to 5:1 or 8:1.

The application provides a power conversion circuit, which is used for converting a 48V input voltage into a front-stage proportional converter of an intermediate bus voltage, and can meet the requirement that the ratio of the input voltage to the output voltage is 5:1 or even 8:1, so that the input voltage of a rear-stage voltage regulator is reduced, and the reliability of a rear-stage voltage regulator is improved. By optimizing the winding mode of the transformer winding and the layout of the power device, the low loss and the small volume of the front-stage proportional converter are realized. Furthermore, the application provides an auxiliary power supply circuit. In the application of large voltage difference between the input voltage and the auxiliary power supply output voltage of the power conversion device, the cross-regulation rate between multiple of output voltages of the auxiliary power supply circuit can be met, and the precision of the input voltage detected on the output side can be improved.

### SUMMARY

In view of the above, one of the objectives of the application is to provide a power conversion device comprises an input end, an output end, a first switch bridge arm, a second switch bridge arm, a first flying capacitor, a second flying capacitor, an output capacitor and a magnetic assembly; the input end comprises an input positive terminal and an input negative terminal, and the output end comprises an output positive terminal and an output negative terminal; the first switch bridge arm comprises a first upper switch, a first middle switch and a first lower switch which are sequentially connected in series; wherein the first upper switch and the first middle switch are connected in series to the first upper node, the first middle switch and the first lower switch are connected in series to a first lower node; the second switch bridge arm comprises a second upper switch, a second middle switch and a second lower switch which are sequentially connected in series; the second upper switch and the second middle switch are connected in series to a second upper node, and the second middle switch and the second lower switch are connected in series to a second lower node;

The magnetic assembly comprises a first side surface, a second side surface, a third side surface and a fourth side surface, the first side surface and the third side surface are opposite, and the second side surface and the fourth side surface are opposite; the first middle switch, the first upper switch, the second upper switch and the second middle switch are sequentially arranged close to the second side surface; the first lower switch and the second lower switch are arranged between the fourth side surface and the output capacitor;

The magnetic assembly further comprises a magnetic core, a first primary winding, a second primary winding, a first secondary winding and a second secondary winding; the first end and the second end of the first primary winding, and the first end and the second end of the second primary winding are arranged close to the second side surface; the first end and the second end of the first secondary winding, and the first end and the second end of the second secondary winding are arranged close to the fourth side surface;

The first flying capacitor and the second flying capacitor are disposed adjacent to the second side surface. The first flying capacitor is bridged between the first upper node and the first end of the first primary winding, and the second end of the first primary winding is electrically connected with the second lower node; the second flying capacitor is bridged between the second upper node and the first end of the second primary winding, and the second end of the second primary winding is electrically connected with the first lower node.

Preferably, the power conversion device further comprises a circuit substrate and an input capacitor; the circuit substrate comprises an upper surface and a lower surface which are opposite to each other; the first upper switch, the second upper switch, the first middle switch, the second middle switch, the first lower switch, the second lower switch and part of the output capacitors are arranged on the upper surface; the input capacitor, the first/second flying capacitor and the other part of the output capacitors are arranged on the lower surface; the input capacitor is bridged at the input end, and the output capacitor is bridged at the output end.

Preferably, wherein the magnetic core comprises three magnetic columns and two magnetic substrates, the three magnetic columns are arranged between the two magnetic substrates, and the magnetic columns are respectively a first side column, a middle column and a second side column; the circuit substrate comprises three holes, or two holes and a hole groove, and the magnetic columns penetrate through the holes or the hole grooves respectively;

The circuit substrate further comprises a first winding area and a second winding area, the first winding area is arranged between the first side column and the middle column, and the second winding area is arranged between the second side column and the middle column; and the first winding area and the second winding area penetrate through the second side surface and the fourth side surface; the first end of the first primary winding is electrically connected with a first flying capacitor, the second end of the first primary winding is electrically connected with a second lower node, and the first primary winding winds a circle around the middle column and the second side column in the clockwise direction; the first end of the second primary winding is electrically connected with a second flying capacitor, the second end of the second primary winding is electrically connected with a first lower node, and the second primary winding winds the middle column and the first side column in the anticlockwise direction for a circle; the first end of the first secondary side winding is electrically connected with a first lower node, the second end of the first secondary side winding is electrically connected with the positive electrode of the output capacitor, and the first secondary side winding winds a circle around the middle column in the anticlockwise direction; the first end of the second secondary side winding is electrically connected with a second lower node, the second end of the second secondary side winding is electrically connected with the positive electrode of the output capacitor, and the second secondary side winding winds a circle around the middle column in the clockwise direction.

Preferably, wherein a first end of the first high-voltage winding, a second end of the second high-voltage winding, a second end of the first secondary winding, and a first end of the second secondary winding are dotted terminals.

Preferably, the power conversion device further comprises another first lower switch and another second lower switch. The other first lower switch and the other second lower switch are arranged on the lower surface of the circuit substrate. The first lower switch and the other first lower switch are arranged in a one-to-one correspondence mode, and the second lower switch and the other second lower switch are arranged in a one-to-one correspondence mode.

Preferably, wherein the power consumption of the other first lower switch is 35%-65% of the power consumption of the first lower switch, and the power consumption of the other second lower switch is 35%-65% of the power consumption of the second lower switch.

Preferably, wherein the input capacitor comprises a first input capacitor and a second input capacitor, the first input capacitor is bridged between the input positive terminal and the input negative terminal, and the second input capacitor is bridged between the input positive terminal and the output positive terminal.

Preferably, wherein the short wiring of the first high-voltage winding located on the first side surface and the short wiring between the second input capacitor and the output positive terminal are laid in a staggered mode, or the short wiring of the first high-voltage winding located on the first side surface and the short wires between the first input capacitor and the output negative terminal are laid in a staggered mode; the short wiring of the second high-voltage winding located on the third side surface and the short wiring between the second input capacitor and the output positive terminal are laid in a staggered mode or the short wiring of the second high-voltage winding located on the third side surface and are staggered with the short wiring between the first input capacitor and the output negative terminal.

Preferably, wherein the first flying capacitor, the input capacitor and the second flying capacitor are sequentially arranged on the bottom surface; the first flying capacitor is arranged adjacent to the first side surface, and the second flying capacitor is arranged adjacent to the second side surface.

Preferably, the input capacitor comprising the first input capacitor and the second input capacitor, the first input capacitor is bridge-connected between the input positive terminal and the input negative terminal, the second input capacitor is bridge-connected between the input positive terminal and the output positive terminal.

A power conversion device comprises a first six-switch circuit, a second six-switch circuit, a magnetic core and a substrate, wherein the magnetic core is arranged on the substrate; and the magnetic core comprises a first side surface and a third side surface which are opposite to each other, and an opposite second side surface and a fourth side surface; the first six-switch circuit is arranged adjacent to the second side surface of the magnetic core, and the second six-switch circuit is arranged adjacent to the fourth side surface of the magnetic core; each six-switch circuit comprises a first three-switch bridge arm and a second three-switch bridge arm, and each three-switch bridge arm comprises an upper switch, a middle switch and a lower switch which are electrically connected in series.

Preferably, a lower switch in the first six-switch circuit and a lower switch in the second six-switch circuit are in mirror symmetry along the Y-direction center line of the magnetic core.

Preferably, the upper switch of the first three-switch bridge arm in each six-switch circuit are electrically connected in parallel, and the upper switch of the second three-switch bridge arm in each six-switch circuit are electrically connected in parallel; the middle switch of the first three-switch bridge arm in each six-switch circuit are electrically connected in parallel, and the middle switch of the second three-switch bridge arm in each six-switch circuit are electrically connected in parallel; and the lower switch of the first three-switch bridge arm in each six-switch circuit are electrically connected in parallel, and the lower switch of the second three-switch bridge arm in each six-switch circuit are electrically connected in parallel.

Preferably, the power conversion device further comprises an output capacitor, the output capacitor is arranged adjacent to the second side surface and the fourth side surface of the magnetic core respectively, and the output capacitor arranged adjacent to the second side surface of the magnetic core and the output capacitor arranged on the fourth side surface of the magnetic core are in mirror symmetry along the Y-direction center line of the magnetic core.

Preferably, the power conversion device further comprises an input capacitor, an input terminal and an output terminal; the input capacitor, the input terminal and the output terminal are respectively arranged adjacent to the second side surface and the fourth side surface of the magnetic core; and the input terminal, the input capacitor and the output terminal are sequentially arranged in the Y direction of the magnetic core.

Preferably, the power conversion device further comprises a Vo+ network, a GND network and an output terminal; the output terminal comprises an output positive terminal and an output negative terminal; the Vo+ network is electrically connected with the output positive terminal, and the GND network is electrically connected with the output negative terminal; and the Vo+ network and the GND network are both arranged on the substrate and surround one circle of the magnetic core.

Preferably, the middle switch in the first six-switch circuit and the middle switch in the second six-switch circuit are in mirror symmetry along the Y-direction center line of the magnetic core; and the upper switch in the first six-switch circuit and the upper switch in the second six-switch circuit are in mirror symmetry along the Y-direction center line of the magnetic core.

Preferably, the upper switch and the middle switch of the first three-switch bridge arm in each six-switch circuit are electrically connected to the first upper node, and the middle switch and the lower switch of the first three-switch bridge arm in each six-switch circuit are electrically connected to the first lower node; the upper switch and the middle switch of the second three-switch bridge arm in each six-switch circuit are electrically connected to the second upper node, and the middle switch and the lower switch of the second three-switch bridge arm in each six-switch circuit are electrically connected to the second lower node; the wirings of the first upper node and the second upper node on the substrate are arranged along the first side surface or the third side surface of the magnetic core; and the wirings of the first lower node and the second lower node on the substrate is arranged along the third side surface or the first side surface of the magnetic core.

Preferably, each six-switch circuit comprises a first flying capacitor, a second flying capacitor, a first high-voltage winding, a second high-voltage winding, a first low-voltage winding and a second low-voltage winding; the first flying capacitor and the first high-voltage winding are electrically connected in series and bridged between the first upper node and the second lower node, the first end of the first high-voltage winding is electrically connected with the first flying capacitor, and the second end of the first high-voltage winding is electrically connected with the second lower node; the second flying capacitor and the second high-voltage winding are electrically connected in series and are bridged between the second upper node and the first lower node, the first end of the second high-voltage winding is electrically connected with the second flying capacitor, and the second end of the second high-voltage winding is electrically connected with the first lower node; the first end of the first low-voltage winding is electrically connected with a first lower node, and the second end of the first low-voltage winding is electrically connected with the output positive terminal; the first end of the second low-voltage winding is electrically connected with a second lower node, and the first end of the second low-voltage winding is electrically connected with the output positive terminal; and the first end of the first high-voltage winding, the second end of the second high-voltage winding, the second end of the first low-voltage winding and the first end of the second low-voltage winding are the dotted terminals.

Preferably, the magnetic core comprises a first side column, a middle column and a second side column; the first side column, the middle column and the second side column are sequentially arranged in the same direction; a first winding area is arranged between the first side column and the middle column, and a second winding area is arranged between the second side column and the middle column; and the first high-voltage winding and the second high-voltage winding in the same six-switch circuit are wound around the middle column by a circle and the winding direction from the first end to the second end of the first high-voltage winding is opposite to the winding direction from the first end to the second end of the second high-voltage winding; and the first low-voltage winding and the second low-voltage winding in the same six-switch circuit penetrate through the first winding area and the second winding area respectively, and the direction of the first low-voltage winding passing through the winding area from the first end to the second end is the same as the direction of each high-voltage winding from the first end to the second end penetrating through the same winding area.

Preferably, each device in the first six-switch and the corresponding devices in the second six-switch circuit are in mirror symmetry along the Y-direction center line of the magnetic core.

A power conversion device, comprising a high-voltage switch, a high-voltage winding, a low-voltage switch, a low-voltage winding, a magnetic core and a substrate, wherein the magnetic core is arranged on the substrate; the magnetic core comprises a first side surface and a third side surface which are opposite to each other, and an opposite second side surface and a fourth side surface; the high-voltage switch is arranged adjacent to the third side surface of the magnetic core; the low-voltage switch is arranged adjacent to the second side surface and the fourth side surface of the magnetic core;
the magnetic core comprises a first side column, a middle column and a second side column; the first side column, the middle column and the second side column are sequentially arranged in the same direction; the high-voltage winding and low-voltage winding are separately wound around the middle column for a circle.

Preferably, a first winding area is arranged between the first side column and the middle column, and a second winding area is arranged between the second side column and the middle column; the first winding area and the second winding area penetrate the second side surface and the fourth side surface, and opening of winding areas are formed on the second side surface and the fourth side surface; the low-voltage switch are arranged close to the openings of winding areas.

Preferably, the circuit substrate comprises hole and/or hole groove, and the magnetic columns penetrate through the holes and/or the hole grooves respectively; the magnetic core further comprises an upper magnetic substrate and a lower magnetic substrate, and the upper magnetic substrate and the lower magnetic substrate are buckled the substrate from the upper surface and the lower surface respectively; the windings are disposed in the substrate.

Preferably, the power conversion device further comprises an input positive terminal and an input negative terminal, an output positive terminal and an output negative terminal; the high-voltage switch comprises a first upper switch, a second upper switch, a first middle switch and a second middle switch; the first upper switch is bridge-connected between the input positive terminal and a first upper end; the first middle switch is bridge-connected between the first upper node and a first lower node; the second upper switch is bridge-connected between the input positive terminal and a second upper node; the second middle switch is bridge-connected between the second upper node and a second lower node;

The low-voltage switch comprises a first lower switch and a second lower switch; the first lower switch is bridge-connected between the first lower node and the input negative terminal; the second lower switch is bridge-connected between the second lower node and the input negative terminal.

Preferably, the low-voltage winding comprises the first low-voltage winding and the second low-voltage winding; the first end of the first low-voltage winding is electrically connected with the first lower node; the first end of the second low-voltage winding is electrically connected with the second lower node; the second end of the first low-voltage winding and the second end of the second low-voltage winding are electrically connected with the output positive terminal.

Preferably, the power conversion device further comprises a first flying capacitor and a second flying capacitor; the high-voltage winding comprises a first high-voltage winding and a second high-voltage winding; the first end of the first flying capacitor is electrically connected with the first upper node, the second end of the first flying capacitor is electrically connected with the first end of the first high-voltage winding, the second end of the first high-voltage winding is electrically connected with the second lower node; the first end of the second flying capacitor is electrically connected with the second upper node, the second end of the second flying capacitor is electrically connected with the first end of the second high-voltage winding, the second end of the second high-voltage winding is electrically connected with the first lower node.

Preferably, the power conversion device further comprises an input capacitor; the input capacitor comprising the first input capacitor and the second input capacitor, the first input capacitor is bridge-connected between the input positive terminal and the input negative terminal, the second input capacitor is bridge-connected between the input positive terminal and the output positive terminal.

Preferably, the power conversion device further comprises an output capacitor, the output capacitor is bridge-connected between the output positive terminal and the output negative terminal; the high-voltage switches and low-voltage switches are disposed on the upper surface of the substrate; the output capacitors are disposed on the lower surface of the substrate, and the output capacitors are arranged in a one-to-one correspondence mode with the low-voltage switches.

Preferably, the input capacitors are arranged adjacent to the high-voltage switch; the first flying capacitor is arranged adjacent to the first upper switch and/or the first middle switch; the second flying capacitor is arranged adjacent to the second upper switch and/or the second middle switch.

Preferably, the power conversion device further comprises the input positive terminal, the input negative terminal, the output positive terminal and the output negative terminal; the low-voltage switch comprises four secondary switch bridge arms, each secondary switch bridge arm comprises a middle-node of the secondary bridge arm; the four secondary switch bridge arms are bridge-connected between the output positive terminal and the output negative terminal; the low-voltage winding comprises a first low-voltage winding and a second low-voltage winding, the first low-voltage winding is bridge-connected between two middle-nodes of the secondary switch bridge arms; the second low-voltage winding is bridge-connected between the other two middle-nodes of the secondary switch bridge arms.

Preferably, the high-voltage switch comprises two primary switch bridge arms; each primary switch bridge arm comprises a middle-node of the primary switch bridge arm; the two primary switch bridge arms are bridge-connected between the input positive terminal and the input negative terminal; the power conversion device further comprises a resonant capacitor, the resonant capacitor and the high-voltage winding are electrically connected and bridge-connected between the two middle-nodes of the primary switch bridge arms.

Preferably, the low-voltage switches are disposed on the upper surface and the lower surface of the substrate; the low-voltage switch on the upper surface and the low-voltage switch on the lower surface are in one-to-one correspondence mode.

Preferably, the power conversion device further comprises an input capacitor, an output capacitor, input terminals and output terminals, the input capacitor and input terminals are disposed adjacent to the high-voltage switch; the output capacitor and the output terminals are disposed adjacent to the low-voltage switch.

A start-up device for a power conversion device, the power conversion device comprises an input positive terminal, an input negative terminal, an output positive terminal and an output negative terminal, a plurality of switches and magnetic assembly; the magnetic assembly comprises a magnetic core and a winding;

The start-up device comprises an auxiliary power supply circuit, and the auxiliary power supply circuit comprises an input capacitor, an LDO circuit, an input circuit, a step-down circuit, a first auxiliary output voltage, and an auxiliary output capacitor; and the first auxiliary output voltage is a voltage between an auxiliary output positive terminal and an input negative terminal; the LDO circuit is electrically connected with the input positive terminal, the input negative terminal and the step-down circuit; the input circuit, the step-down circuit and the LDO circuit are electrically connected with the auxiliary input connection point; the input circuit comprises an auxiliary input winding, and the auxiliary input winding is coupled with a winding of the magnetic assembly; and the first auxiliary output voltage is the output voltage of the step-down circuit;

When the power conversion device is started, the step-down circuit receives power supply from the LDO, and the first auxiliary output voltage is established; and when the power conversion device enters a steady state, the input circuit supplies power to the first auxiliary output voltage through the step-down circuit. The input circuit comprises an auxiliary input diode; the positive electrode of the auxiliary input diode is electrically connected the first end of the auxiliary winding; the negative electrode of the auxiliary input diode is electrically connected the auxiliary input connection point; the second end of the auxiliary winding is electrically connected the input negative terminal.

Preferably, the step-down circuit comprises a auxiliary bridge arm, an auxiliary step-down capacitor, a first auxiliary output winding, a second auxiliary output winding and an auxiliary output diode; the auxiliary bridge arm is bridge-connected between the auxiliary input connection point and the input negative terminal, and comprises an upper switch and a lower switch; the upper switch and the lower switch are electrically connected with the middle-point of the auxiliary bridge arm; the auxiliary step-down capacitor, the first auxiliary output winding and the second auxiliary output winding are electrically connected in sequence, and bridge-connected between the middle-point of the auxiliary bridge arm and the first auxiliary output voltage; the first auxiliary output winding and the second auxiliary output winding are wound around a same magnetic core; the positive electrode of the auxiliary diode is electrically connected with the input negative terminal, the negative electrode of the auxiliary diode is electrically connected with the connection point of the two auxiliary output windings.

Preferably, the start-up device further comprises a second auxiliary output circuit, the second auxiliary output circuit comprises a switch and a third auxiliary output winding; the third auxiliary output winding, the first auxiliary output winding and the second auxiliary output winding are wound in a same magnetic core.

### BRIEF DESCRIPTION OF THE DRAWINGS

FIG. 1A is a topology of a power conversion circuit.

FIG. 1B is a schematic timing diagram of a control signal corresponding to each power switch in FIG. 1A.

FIG. 2A is a schematic top view of a power conversion device according to Embodiment 1.

FIG. 2B is a schematic bottom view of a power conversion device according to Embodiment 1.

FIG. 2C is a top exploded view of a power conversion device according to Embodiment 1.

FIG. 2D and FIG. 2E are schematic diagrams of a transformer winding mode and a power device layout according to Embodiment 1.

FIG. 3A is a schematic top view of a power conversion device according to Embodiment 2.

FIG. 3B is a schematic bottom view of a power conversion device according to Embodiment 2.

FIG. 3C is a schematic diagram of a winding mode and a power device layout of a transformer winding according to Embodiment 2.

FIG. 4A is a topology of a power conversion circuit according to Embodiment 3.

FIG. 4B is a top exploded view of the power conversion device according to Embodiment 3.

FIG. 4C is a schematic top view of a power conversion device according to Embodiment 3.

FIG. 4D is a schematic bottom view of the power conversion device according to Embodiment 3.

FIG. 4E is a winding mode of a primary winding of a transformer according to Embodiment 3.

FIG. 4F is a schematic diagram of a winding mode and a power device layout of a secondary winding of a transformer according to Embodiment 3.

FIG. 5A to FIG. 5F are schematic diagrams of a circuit topology, a winding mode and a layout of Embodiment 4.

FIG. 6 is a circuit topology of auxiliary power supply device.

### DESCRIPTION OF THE EMBODIMENTS

One of the cores of the present application is to provide a power conversion circuit, which is used for converting a 48V input voltage into a front-stage proportional converter of an intermediate bus voltage, and can meet the requirement that the ratio of the input voltage to the output voltage is 5:1, thereby reducing the input voltage of a rear-stage voltage regulator and improving the reliability of a rear-stage voltage regulator. By optimizing the winding mode of the transformer winding and the layout of the components, the low loss and the small size of the front-stage proportional converter are realized. Furthermore, the application provides an auxiliary power supply circuit. In the application of large voltage difference between the input voltage and the auxiliary power supply output voltage of the power conversion device, the cross-regulation rate between multiple of output voltages of the auxiliary power supply circuit is met, and the precision of the input voltage detected on the output side can be improved.

According to the technical scheme in the embodiment of the application, the technical scheme in the embodiment of the application is clearly and completely described below in combination with the drawings in the embodiment of the application, obviously, the described embodiments are only a part but not all of the embodiments of the present application on the basis of the embodiments of the present application, all other embodiments obtained by a person of ordinary skill in the art without creative efforts shall fall within the protection scope of the present application.

### Embodiment 1

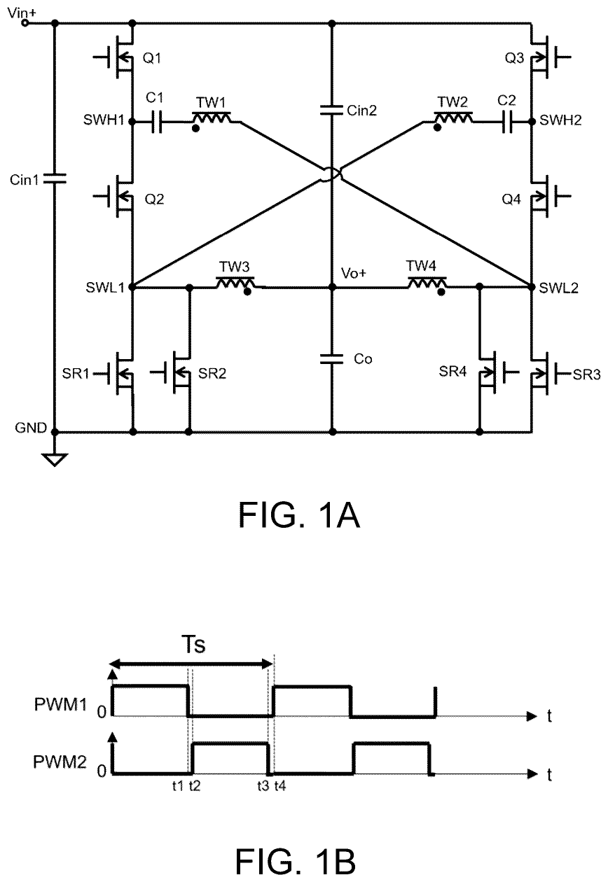

The topology of the power conversion circuit disclosed by the embodiment is shown in FIG. 1A comprising an input terminal Vin, an output terminal Vo, at least one input capacitor Cin1, at least one output capacitor Co, two three-switch bridge arms, a transformer, at least one flying capacitor C1 and at least one flying capacitor C2. The input terminal Vin comprises an input positive terminal Vin+ and an input negative terminal Vin−; the output terminal Vo comprises an output positive terminal Vo+ and an output negative terminal Vo−; and the input negative terminal Vin− is short-circuited with the output negative terminal Vo−. The two three-switch bridge arms are electrically connected in parallel and are connected in parallel with the input capacitor Cin1 and are bridge-connected between the input positive terminal Vin+ and the input negative terminal Vin−; wherein one three-switch bridge arm (equivalent to a first three-switch bridge arm) comprises an upper switch Q1, a middle switch Q2 and two lower switches SR1/SR2; the upper switch Q1 and the middle switch Q2 are electrically connected to the upper node SWH1 in series; and the lower switches SR1 and SR2 are connected in parallel; the middle switch Q2 and the lower switch SR1/SR2 are electrically connected to the lower node SWL1; The other three-switch bridge arm (equivalent to a second three-switch bridge arm) comprises an upper switch Q3, a middle switch Q4 and two lower switches SR3/SR4; and the upper switch Q3 and the middle switch Q4 are electrically connected to the upper node SWH2 in series; and the lower switches SR3 and SR4 are connected in parallel; the middle switch Q4 and the lower switch SR3/SR4 are electrically connected in series to the lower node SWL2. Transformer comprise two high-voltage windings TW1 and TW2 and two low-voltage windings TW3 and TW4; the flying capacitor C1 and the high-voltage winding TW1 are connected in series between the upper node SWH1 and the lower node SWL2, one end of the high-voltage winding TW1 connected with the flying capacitor C1 is a first end, and the end, connected with the lower node SWL2, of the high-voltage winding TW1 is a second end; the flying capacitor C2 and the high-voltage winding TW2 are connected in series between the upper node SWH2 and the lower node SWL1, one end of the high-voltage winding TW2 connected with the flying capacitor C2 is a first end; and the end, connected with the lower node SWL1, of the high-voltage winding TW1 is a second end. The first end of the low-voltage winding TW3 is electrically connected with the lower node SWL1, the first end of the low-voltage winding TW4 is electrically connected with the lower node SWL2, and the second end of the low-voltage winding TW3 and the second end of the TW4 are short-circuited and are electrically connected with the output positive terminal Vo+. The output capacitor Co is bridged between the output positive terminal Vo+ and the output negative terminal Vo−. Another input capacitor Cin2 is connected between the input positive terminal Vin+ and the output positive terminal Vo+, and the capacitor Cin2 and the capacitor Cin1 have similar functional effects, that is, the pulse current generated by the two three-switch bridge arms is filtered out. Compared with the fact that Cin1 is bridged between the input positive terminal Vin+ and the input negative terminal Vin−, Cin2 is bridged between the input positive terminal Vin+ and the output positive terminal Vo+, so that the voltage resistance of Cin2 is low, and the size is small.

FIG. 1B is a timing diagram of control signals of the six power switches of FIG. 1A. The control signal comprises a first control signal PWM1 and a second control signal PWM2. The duty ratio of the first control signal PWM1 to the second control signal PWM2 is close to 50% respectively, and the phase-shift is 180 degrees. The first control signal PWM1 is used for controlling the turn-on and turn-off of the upper switch Q1 and the middle switch Q4 and the lower switch SR1/SR2; and the second control signal PWM2 is used for controlling the turn-on and turn-off of the upper switch Q3 and the middle switch Q2 and the lower switch SR3/SR4. The interval between time 0 and time t6 is one switching period TS of the power conversion circuit, and the switching frequency of the upper switch Q1 or Q3 is defined as the switching frequency fsw of the power conversion circuit.

A second end of the low-voltage winding TW3, a first end of the low-voltage winding TW4, a first end of the high-voltage winding TW1, and a second end of the high-voltage winding TW2 are same polarity ends and are marked as point ends; namely the windings TW1 and TW4 are connected in series in the forward direction; and the windings TW2 and TW3 are also connected in series in the forward direction; Adopting the circuit topology, the ratio of the input voltage to the output voltage can be increased by increasing the number of turns of TW1 and TW2, so that the range of output voltage is obtained.

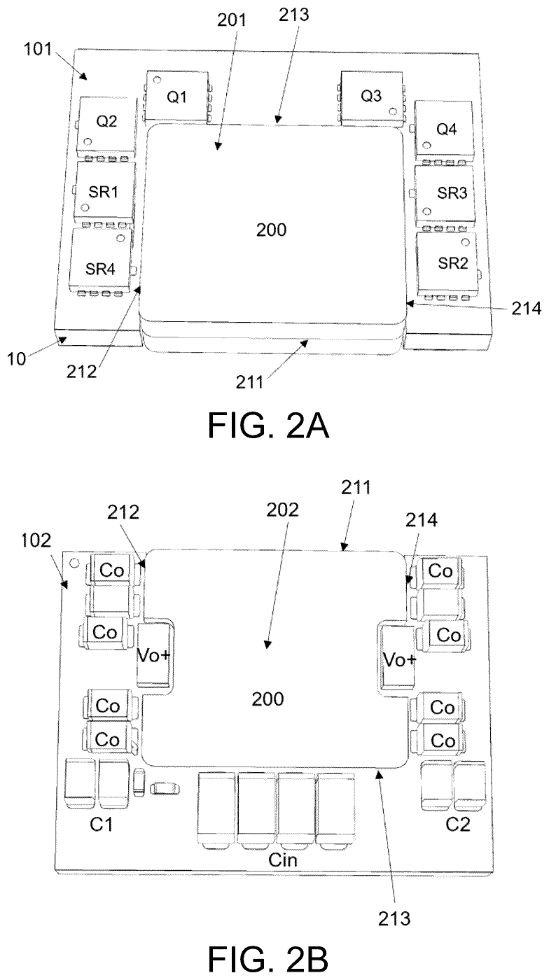

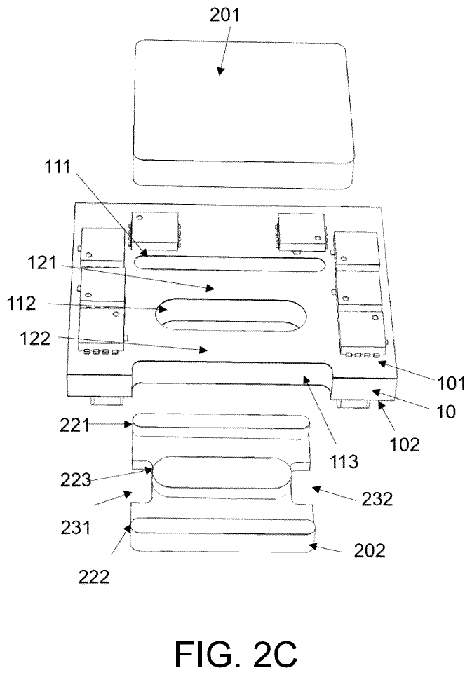

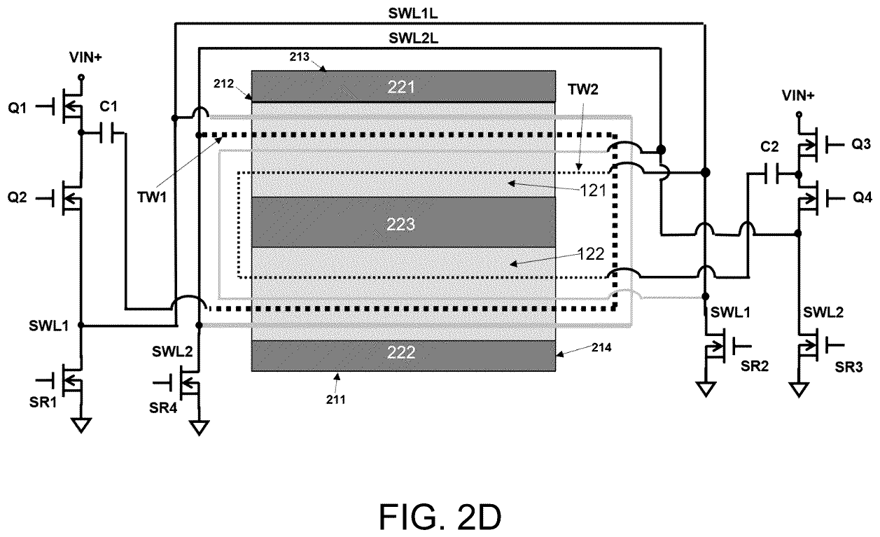

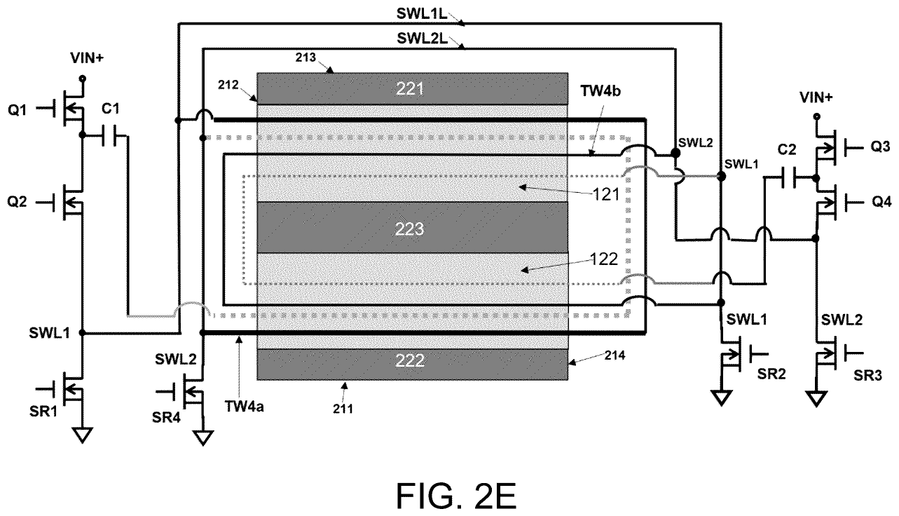

The embodiment also discloses a power conversion device applying the circuit topology shown in FIG. 1A, as shown in FIG. 2A to FIG. 2C. FIG. 2A is a schematic top view of a power conversion device, FIG. 2B is a schematic bottom view of the power conversion device, and FIG. 2C is a top view decomposition schematic diagram.

The power conversion device comprises a circuit substrate 10, a magnetic assembly 200, an upper switch Q1/Q3, a middle switch Q2/Q4, a lower switch SR1/SR2/SR3/SR4, flying capacitors C1 and C2, an output capacitor Co and an input capacitor Cin; the input capacitor Cin corresponding to the input capacitor Cin1 or the input capacitor Cin2 in FIG. 1A. The magnetic assembly comprises an upper magnetic substrate 201, a lower magnetic substrate 202, side columns 221/222 and a middle column 223. The side column 221, and the middle column 223 and the side column 222 are arranged in sequence and are arranged between the upper magnetic substrate 201 and the lower magnetic substrate 202. The circuit substrate 10 comprises an upper surface 101 and a lower surface 102 opposite to each other, a hole 111/112 and a groove hole 113. The hole 111/112 and the groove hole 113 penetrate through the upper surface 101 and the lower surface 102 to allow the side column 221, the middle column 223 and the side column 222 to pass through. The upper magnetic substrate 201 and the lower magnetic substrate 202 are respectively buckled the circuit substrate 100 from the upper surface 101 and the lower surface 102. The area between the hole 111 and 112 is a first winding area 121 (equivalent to a channel between the side column 221 and the middle column 223), and the area between the hole 112 and the groove hole 113 is a second winding area 122 (i.e., a channel between the middle column 223 and the side column 222). The magnetic assembly 200 comprises a first side surface 211, a second side surface 212, a third side surface 213 and a fourth side surface 214, wherein the first side surface 211 and the third side surface 213 are opposite to each other, and the second side surface 212 and the fourth side surface 214 are opposite; and the second side surface 212 and the fourth side surface 214 are respectively located at the opening positions on the two sides of the first winding area 121 or the second winding area 122. The upper switch Q1/Q3, the middle switch Q2/Q4 and the lower switch SR1/SR2/SR3/SR4 are arranged on the upper surface 101 of the circuit substrate. The switch Q1 is arranged adjacent to the third side surface 213 and the second side surface 212; the middle switch Q2 and the lower switch SR1/SR4 are arranged adjacent to the second side surface 212; the upper switch Q1, the middle switch Q2 and the lower switch SR1 and SR4 form a first switch unit; the upper switch Q1, the middle switch Q2, the lower switch SR1 and the lower switch SR4 are sequentially arranged from top to bottom; and the lower switch SR1/SR4 is respectively close to the first winding area and the second winding area. The upper switch Q3 is arranged adjacent to the third side surface 213 and the fourth side surface 214; the middle switch Q4 and the lower switch SR2/SR3 are arranged close to the fourth side surface 214. The upper switch Q3, the middle switch Q4 and the lower switch SR2 and SR3 form a second switch unit; and the upper switch Q3, the middle switch Q4, the lower switch SR3 and the lower switch SR2 are sequentially arranged from top to bottom, and the lower switch SR3/SR2 is close to the first winding area and the second winding area respectively.

The output capacitor Co, the input capacitor Cin, the flying capacitors C1 and C2 and the two output positive terminal parts Vo+ are arranged on the lower surface 102 of the circuit substrate. The lower magnetic substrate 202 comprises notches 223 and 224, which are respectively arranged on the second side surface 212 and the fourth side surface 214. The two output positive terminal parts Vo+ are respectively arranged in the notch 223 and in the notch 224. A part of the output capacitor Co is arranged adjacent to the second side surface 212 and is adjacent to one output positive terminal Vo+; the other part of the output capacitor Co is arranged adjacent to the fourth side surface 214 and is adjacent to the other output positive terminal Vo+; the input capacitor Cin is arranged adjacent to the third side surface 213; the flying capacitor C1 is arranged adjacent to the second side surface 212 and the third side surface 213, and the flying capacitor C2 is arranged adjacent to the third side surface 213 and the fourth side surface 214.

The application also discloses a winding mode of the winding, as shown in FIG. 2D and FIG. 2E. The first and second ends of the high voltage winding TW1 are disposed adjacent to the second side surface 212 of the magnetic assembly 200; the first end of the high-voltage winding TW1 is electrically connected to the flying capacitor C1, and the second end of the high-voltage winding TW1 is electrically connected to the drain of the lower switch SR4, that is, the lower node SWL2. The high-voltage winding TW1 starts from the first end, passes through the second winding area 122 in the first direction (i.e., from left to right) in sequence, is wound along the fourth side surface 214, and then passes through the first winding area 121 in the second direction (ie, from right to left) to reach the second end; in other words, the high-voltage winding TW1 is wound around the middle column 223 in a counterclockwise direction to form a circle. The first end and the second end of the high-voltage winding TW2 are both disposed adjacent to the fourth side 214 of the magnetic assembly 200; the first end of the high-voltage winding TW2 is electrically connected to the flying capacitor C2, and the second end of the high-voltage winding TW1 is electrically connected to the drain of the lower switch SR2, that is, the lower node SWL1. The high-voltage winding TW2 starts from the first end, passes through the second winding area 122 in the second direction (ie, from right to left), is wound along the second side surface 212, and then passes through the first winding area 121 in the first direction (i.e., from left to right) in sequence, and then reaches the second end; in other words, the high-voltage winding TW2 is wound around the middle column 223 in the clockwise direction to form a circle.

As shown in FIG. 2E, the low-voltage winding TW3 is divided into TW3a and TW3b; TW3a and TW3b are connected in parallel; the first end of TW3a and the second end of TW3b are disposed adjacent to the second side surface 212, and the second end of TW3a and the first end of TW3b are disposed adjacent to the fourth side surface 214. The low-voltage winding TW3a starts from the first end, passes through the first winding area 121 in the first direction, and reaches the second end (Vo+ end) of the low-voltage winding TW3a. The low-voltage winding TW3b starts from the first end, passes through the second winding area 122 in the second direction, and reaches the second end (Vo+ end) of the low-voltage winding TW3b. The low voltage winding TW4 is divided into TW4a and TW4b; TW4a and TW4b are connected in parallel; the first end of TW4a and the second end of TW4b are arranged adjacent to the second side surface 212, and the second end of TW4a and the first end of TW4b are arranged adjacent to the fourth side surface 214. The low-voltage winding TW4a starts from the first end, passes through the second winding area 122 in the first direction, and reaches the second end (Vo+ end) of the low-voltage winding TW4a. The low-voltage winding TW4b starts from the first end, passes through the first winding region 121 in the second direction, and reaches the second end (Vo+ end) of the low-voltage winding TW4b. The second end of the low-voltage winding TW3a and the second end of the low-voltage winding TW4a are shorted to the output positive terminal Vo+ of the fourth side surface 214; and the second end of the low-voltage winding TW3b and the second end of the low-voltage winding TW4b are shorted to the output positive terminal Vo+ of the second side surface 212. The first end of the low-voltage winding TW3a and the first end of the low-voltage winding TW3b are short-circuited through the short wiring SWL1L surrounding the second side surface 212, the third side surface 213 and the fourth side surface 214 of the magnetic assembly 200. The first end of the low-voltage winding TW4a is short-circuited with the first end of the low-voltage winding TW4b through a short wiring SWL2L surrounding the second side surface 212, the third side surface 213 and the fourth side surface 214 of the magnetic assembly 200. The short wiring SWL1L and the SWL2L are all arranged at the third side surface 213 of the magnetic assembly 200, and the currents flowing through the two short wiring are approximately equal in magnitude and opposite in direction; and the two short wiring lines are arranged on the wiring layers in a staggered mode, so that the alternating current loss caused by the current flowing through the two short wirings is minimum. In the embodiment, through coupling of the two half-turn low-voltage windings TW3 and TW4 with the two one-turn high-voltage windings TW1 and TW2, the ratio of the input voltage to the output voltage is 8:1.

According to the embodiment of the application, the switch device in the circuit topology in FIG. 1A is split into two switch units, which are specifically a first switch unit and a second switch unit. The first switch unit comprises an upper switch Q1, a middle switch Q2 and lower switches SR1 and SR4. The second switch unit comprises an upper switch Q3, a middle switch Q4 and lower switches SR2 and SR3. The first switch unit and the second switch unit are respectively arranged between the second side surface 212 and the fourth side surface 214 of the magnetic assembly 200. The flying capacitor C1 is bridged between the upper node of the first switch unit and the first end of the high-voltage winding TW1. The flying capacitor C2 is bridged between the upper node of the second switching unit and the first end of the high-voltage winding TW2. According to the transformer winding method in the embodiment, namely the four secondary side windings of half turns and a winding method of two primary side windings of one turn, and the matched layout method of the power device, so that the parasitic resistance of the transformer winding is small, and the loss is low; and under the condition that the lower switch keeps the minimum wiring parasitic resistance, the number of the lower switches is doubled on the upper surface 101 of the circuit substrate, and the loss of the switching devices is reduced. In addition, the parasitic resistance of the power wiring outside the transformer winding is reduced, and the power loss of the power conversion device is further reduced.

### Embodiment 2

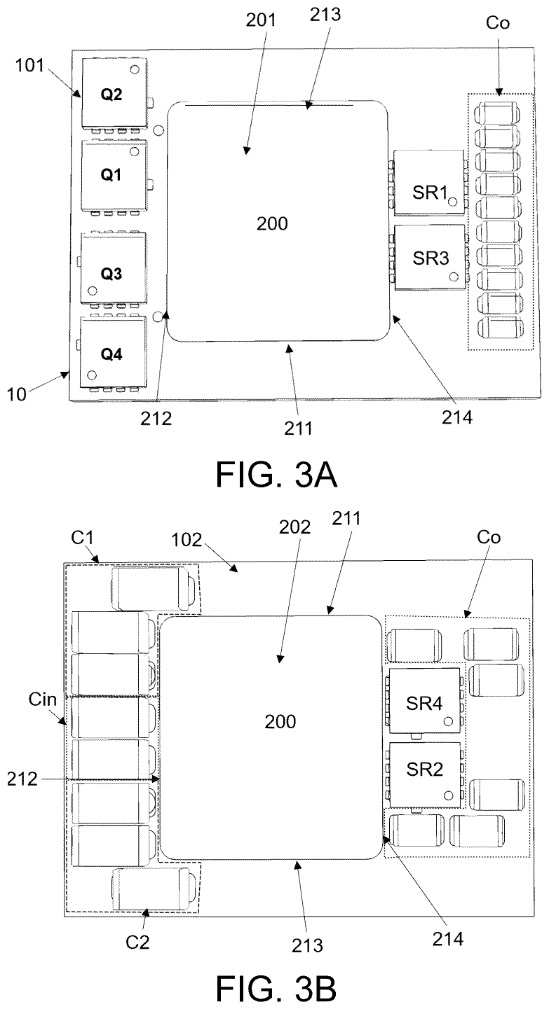

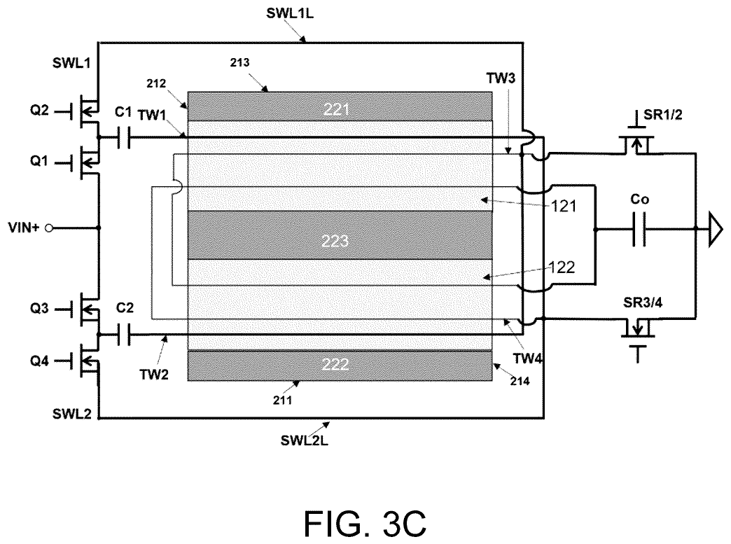

Another power conversion device is also disclosed, as shown in FIGS. 3A-3B. FIG. 3A is a schematic top view of a power conversion device, and FIG. 3B is a schematic bottom view of the power conversion device.

The power conversion device comprises a circuit substrate 10, a magnetic assembly 200, an upper switch Q1/Q3, a middle switch Q2/Q4, a lower switch SR1/SR2/SR3/SR4, flying capacitors C1 and C2, an output capacitor Co and an input capacitor Cin, wherein the input capacitor Cin is corresponding to the input capacitor Cin1 or the input capacitor Cin2 in FIG. 1A In the embodiment. The structure of the magnetic assembly 200 is the same as the structure of the magnetic assembly shown in the first embodiment. The circuit substrate 10 comprises an upper surface 101 and a lower surface 102 opposite to each other, and a hole 111/112/114. The holes 111/112/114 penetrate through the upper surface 101 and the lower surface 102 to allow the side columns 221 and the middle columns 223 and the side columns 222 to penetrate in a one-to-one correspondence mode. The upper magnetic substrate 201 and the lower magnetic substrate 202 are respectively buckled the circuit substrate 100 from the upper surface 101 and the lower surface 102. The area between the hole 111 and 112 is a first winding area 121 (equivalent to a channel between the side column 221 and the middle column 223), and the area between the holes 112 and 114 is a second winding area 122 (equivalent to a channel between the middle column 223 and the side column 222). The magnetic assembly 200 comprises a first side surface 211, a second side surface 212, a third side surface 213 and a fourth side surface 214, wherein the first side surface 211 and the third side surface 213 are opposite to each other, and the second side surface 212 and the fourth side surface 214 are opposite; and the second side surface 212 and the fourth side surface 214 are respectively located at the opening positions on the two sides of the first winding area 121 or the second winding area 122. An upper switch Q1/Q3, a middle switch Q2/Q4, a lower switch SR1/SR3 and a part of output capacitors Co are arranged on the upper surface 101 of the circuit substrate. The flying capacitor C1/C2, the input capacitor Cin, the other part of the output capacitors Co and the lower switch SR2/SR4 are arranged on the lower surface 102 of the circuit substrate. The switches Q1/Q3 and the middle switch Q2/Q4 are arranged close to the second side surface 212 of the magnetic assembly 200, and the switches Q1/Q3 and the middle switch Q2/Q4 are sequentially arranged according to the sequence of the middle switch Q2, the upper switch Q1, the upper switch Q3 and the middle switch Q4; and the drain electrode of the upper switch Q1 and the drain electrode of the Q3 are adjacent and short-circuited; the source electrode of the upper switch Q1 and the drain electrode of the middle switch Q2 are adjacent and short-circuited; and the drain electrode of the upper switch Q3 and the source electrode of the middle switch Q4 are adjacent and short-circuited, the lower switch SR1/SR2/SR3/SR4 is arranged adjacent to the fourth side surface 214; and the lower switches SR1 and SR2 are connected in parallel; the projection of the lower switch SR1 on the upper surface 101 at least partially coincides with the projection of the lower switch SR2 on the upper surface 101; the lower switch SR3 and SR4 are connected in parallel, and the projection of the lower switch SR3 on the upper surface 101 at least partially coincides with the projection of the lower switch SR4 on the upper surface 101. Considering the application occasion of adding the radiator to the top surface of the power conversion device, the heat dissipation path of the lower switches SR2 and SR4 of the lower surface 102 of the circuit substrate is long, and the heat dissipation thermal resistance is large. In the embodiment, the power consumption of the lower switch SR2 is designed to be about 50% of SR1; similarly, the power consumption of the lower switch SR4 is designed to be about 50% of SR3. Therefore, the lower switches SR2 and SR4 of the lower surface 102 of the circuit substrate cannot become the hot spot bottleneck of the power device. Here, 50% may be defined as between 35% and 65%.

A drain of the lower switches SR1 and SR3 is close to the third side surface 213. The sources of the lower switches SR1 and SR3 are shorted and s disposed away from the third side surface 213. The capacitor Co is arranged adjacent to the sources of the lower switches SR1 and SR3. The lower switches SR1 and SR3 are disposed between the magnetic assembly 200 and the output capacitor Co. On the lower surface 102, the input capacitor Cin is arranged adjacent to the second side surface 212, wherein the negative electrode of the input capacitor Cin is close to the second side surface 212, the positive electrode of the input capacitor Cin is far away from the second side surface 212. On the lower surface 102, part of the output capacitor Co is arranged adjacent to the lower switch SR2 and SR4, and the lower switch SR2 and SR4 are arranged between the magnetic assembly 200 and part of the output capacitor Co. The flying capacitor C1 and the flying capacitor C2 are respectively arranged on two sides of the input capacitor Cin and are arranged adjacent to the second side surface 212. A terminal of the flying capacitor C1 short-circuited with the first end of the high-voltage winding TW1 is close to the first winding area 121, the terminal short-circuited between the flying capacitor C1 and the first end of the high-voltage winding TW2 is away from the first winding area 121. The terminal short-circuited between the flying capacitor C2 with the first end of the high-voltage winding TW2 is close to the second winding area 122, and the terminal short-circuited between the flying capacitor C2 and the upper node SWH2 is far away from the second winding area 122.

The application also discloses a winding mode of the transformer winding, as shown in FIG. 3C. The first end and the second end of the high-voltage windings TW1 and TW2 are both arranged adjacent to the second side surface 212. The high-voltage winding TW1, from the first end, penetrates through the first winding area 121 in the first direction (i.e., from left to right), and is wound along the first side surface 211 and the fourth side surface 214, and then reaches the second end of the high-voltage winding TW1 and is short-circuited with the source of Q4. In other words, the high-voltage winding is wound around the middle column 223 and the side column 222 in the clockwise direction to form a circle. The high-voltage winding TW2 passes through the second winding area 122 in the first direction (i.e., from left to right) from the first end and is wound along the third side surface 213 and the fourth side surface 214, and then reaches the second end of the high-voltage winding TW2, and is short-circuited with the source electrode of the Q2. In other words, the high-voltage winding TW2 is wound around the middle column 223 and the side column 221 in the counterclockwise direction to form a circle.

The first and second ends of the low-voltage windings TW3 and TW4 are disposed adjacent to the fourth side surface 214. The first end of the low-voltage winding TW3 starts from the lower node SWL1, passes through the first winding area 121 in the second direction (i.e., from right to left) in sequence, is wound along the second side surface 212, passes through the second winding area 122 in the first direction (i.e., from left to right), and reaches the second end of the low-voltage winding TW3 to be in short connection with the positive electrode of the output capacitor Co; in other words, the low-voltage winding TW3 is wound around the middle column 223 in a counterclockwise direction to form a circle. The first end of the low-voltage winding TW4 starts from the lower node SWL2, passes through the second winding region 122 in a second direction (ie, from right to left) in sequence, is wound along the second side surface 212, passes through the first winding area 121 in the first direction (i.e., from left to right), and reaches the second end of the low-voltage winding TW4 to be short-circuited with the positive electrode of the output capacitor Co; in other words, the low-voltage winding TW4 is wound around the middle column 223 in the clockwise direction to form a circle. In the embodiment, through the winding method of the low-voltage windings and the high-voltage windings; the number of turns of the low-voltage winding TW3 or TW4 is set to be 1 turn, and the number of turns of the high-voltage winding TW1 or TW2 is 0.5 circle, so that the expression of the input voltage and the output voltage of the power conversion device is Vin=5 Vo; that is, the ratio of the input voltage to the output voltage is 5:1. Since the upper switch and the middle switch are arranged on one side of the opening of the first winding area 121 or the second winding area 122, the lower switch is arranged on the other side of the opening of the first winding area 121 or the second winding area 122, so that the transformer winding and the power wiring of the power conversion device are the shortest, and the parasitic resistance of the winding and the power wiring is reduced.

Referring to FIG. 3C and FIG. 1A, the current flowing through the short wiring SWL2L located on of the first side surface 211 is an alternating current. In order to reduce the AC resistance of the short wiring SWL2L, the short wiring of the input capacitor Cin2 and the output positive terminal Vo+ can be laid in a staggered manner on the adjacent layers of the short wiring SWL2L; or the short wiring of the input capacitor Cin1 and the output negative terminal Vo− can be laid in a staggered manner. Similarly, the current flowing through the short wiring SWL1L located on the third side surface 213 is an alternating current, in order to reduce the alternating current resistance of the short wiring SWL1L, the short wiring between the input capacitor Cin2 and the output positive terminal Vo+ can be laid in a staggered manner on the adjacent layers of the short wiring SWL1L; or the short wiring of the input capacitor Cin1 and the output negative terminal Vo− is laid in a staggered manner.

### Embodiment 3

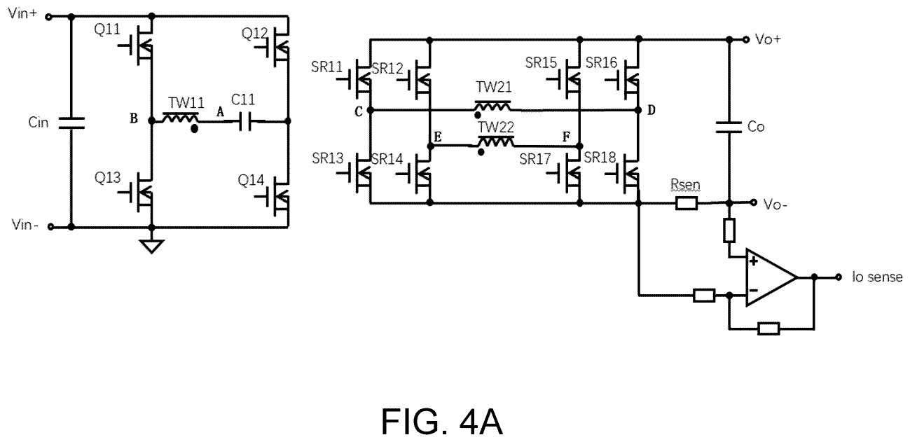

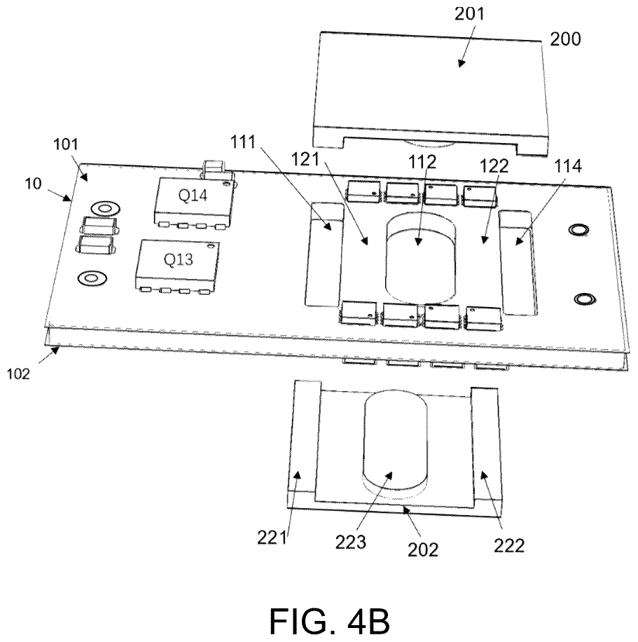

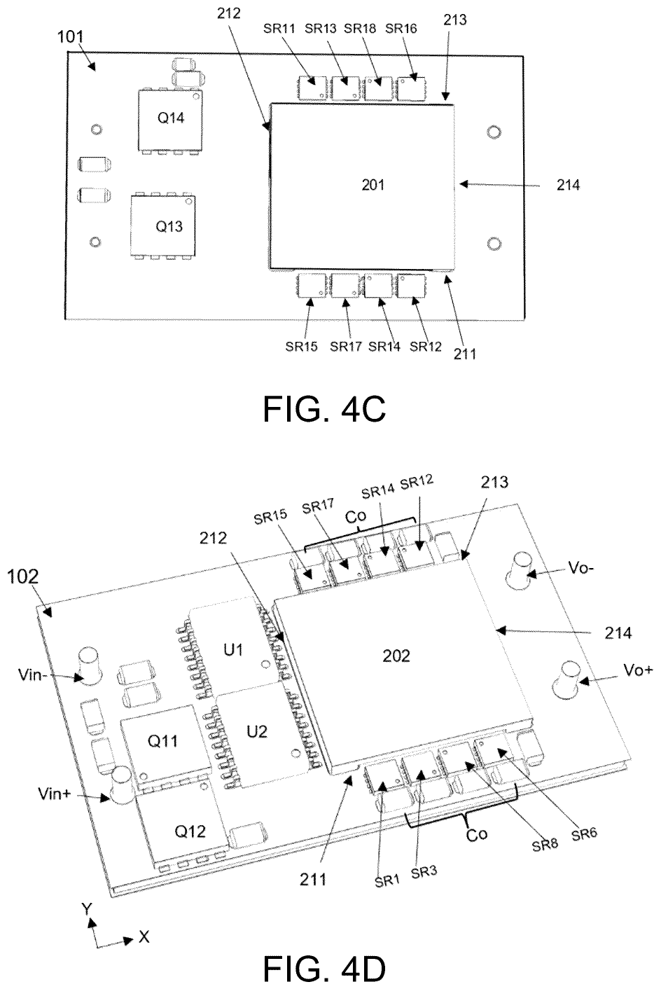

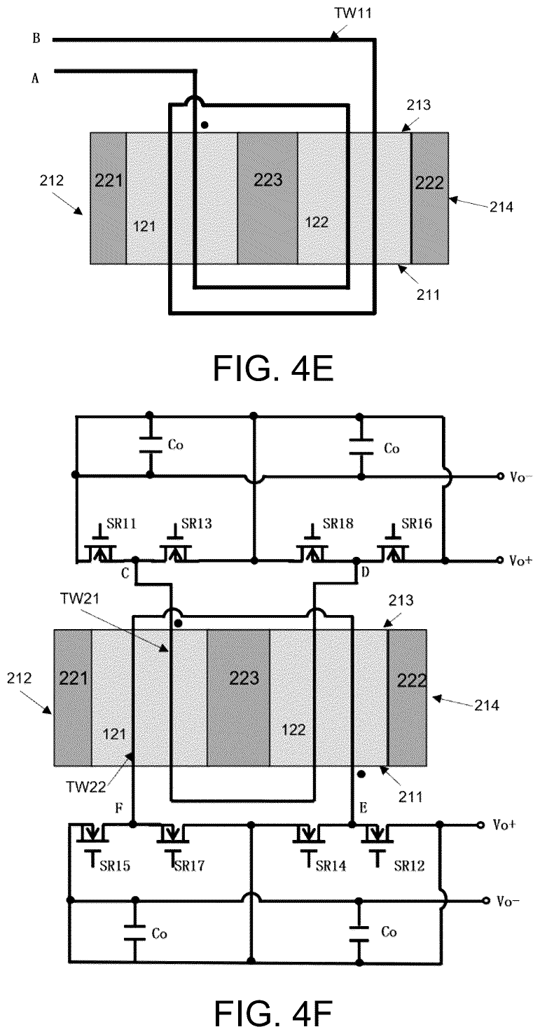

The application also discloses another power conversion circuit topology and a power conversion device thereof, as shown in FIG. 4A to FIG. 4F. The circuit topology disclosed by the embodiment comprises an input end Vin, an output end Vo, at least one input capacitor Cin, at least one output capacitor Co, a primary side circuit, a transformer, a resonant capacitor C11 and a secondary side circuit. The input terminal Vin comprises an input positive terminal Vin+ and an input negative terminal Vin−, and the output terminal Vo comprises an output positive terminal Vo+ and an output negative terminal Vo−. The primary side circuit is a full-bridge circuit and comprises a first primary side switch bridge arms and a second primary side switch bridge arm which are connected in parallel; the first primary side switch bridge arm comprises an upper switch Q11 and a lower switch Q13 which are connected in series, and the source electrode of the upper switch Q11 and the drain electrode of the lower switch Q13 are shorted to form a first primary side switch bridge arm middle point; the second primary side switch bridge arm comprises an upper switch Q12 and a lower switch Q14 which are connected in series, and the source electrode of the upper switch Q12 and the drain electrode of the lower switch Q14 are shorted to form a middle point of the second primary side switch bridge arm. The drains of the upper switches Q11 and Q12 are short-circuited with the input positive terminal Vin+, and the sources of the lower switches Q13 and Q14 are short-circuited with the input negative terminal Vin−. The transformer comprises a primary winding TW11, a secondary winding TW21 and TW22, the primary winding TW11 is connected in series with the resonant capacitor C11 and is bridged between the midpoints of the two primary switching bridge arms; the two ends of the primary winding TW11 are respectively connected with points A and B, the connecting point B is the midpoint of the first primary switching bridge arm, and the connecting point A is the short connection point with the resonant capacitor C11. The secondary side circuit comprises a first secondary side full bridge circuit and a second secondary side full bridge circuit which are connected in parallel. Each secondary side full-bridge circuit comprises two secondary side switch bridge arms, and after all the secondary side switch bridge arms are connected in parallel, the secondary side switch bridge arms are bridged between the output positive terminal Vo+ and the output negative terminal Vo−. The first secondary side switch bridge arm comprises an upper switch SR11 and a lower switch SR13 which are connected in series, and the source electrode of the SR11 and the drain electrode of the SR13 are shorted to form a first secondary side switch bridge arm midpoint C; the second secondary side switch bridge arm comprises an upper switch SR12 and a lower switch SR14 which are connected in series, and the source electrode of the SR12 and the drain electrode of the SR14 are short-circuited to form a second secondary side switch bridge arm midpoint E; the third secondary side switch bridge arm comprises an upper switch SR15 and a lower switch SR17 which are connected in series, and the source electrode of the SR15 and the drain electrode of the SR17 are short-circuited to form a middle point F of the third secondary side switch bridge arm; the fourth secondary side switch bridge arm comprises an upper switch SR16 and a lower switch SR18 which are connected in series, the source electrode of the SR16 and the drain electrode of the SR18 are short-circuited to form a fourth secondary side switch bridge arm midpoint D. The first secondary side full-bridge circuit comprises a first secondary side switch bridge arm and a fourth secondary side switch bridge arm, and the secondary side winding TW21 is bridged between the midpoint C of the first secondary side switch bridge arm and the midpoint D of the fourth secondary side switch bridge arm. The second secondary-side full-bridge circuit comprises a second secondary-side switch bridge arm and a third secondary-side switch bridge arm. The secondary-side winding TW22 is bridged between the midpoint E of the second secondary-side switch bridge arm and the midpoint F of the third secondary-side switch bridge arm. The circuit topology disclosed by the embodiment further comprises a sampling resistor Rsen, wherein Rsen is connected in series between the output negative terminal Vo− and the short-circuit point of the sources of the switches SR1/SR3/SR8/SR6, and Rsen can be an external resistor or a parasitic resistor of the PCB power wiring. The sampling resistor Rsen is used for sampling the output current of the power conversion topology and controlling or monitoring the output current. One end (Vo−) of the sampling resistor Rsen is electrically connected with the positive input end of the operational amplifier. The other end of the sampling resistor Rsen is electrically connected with the negative input end of the operational amplifier; and the output end Io Sense of the operational amplifier outputs a positive voltage to reflect the magnitude of the output current of the power conversion device.

FIG. 4B is a top exploded view of the power conversion device disclosed in the present embodiment, FIG. 4C is a schematic top view of the power conversion device, and FIG. 4D is a schematic bottom view of the power conversion device. In combination with FIG. 4B to FIG. 4D, the power conversion device comprises a circuit substrate 10, a magnetic assembly 200, a plurality of switches, and a resonant capacitor C11; the input capacitor Cin and the output capacitor Co. The magnetic assembly 200 comprise an upper magnetic substrate 201, a lower magnetic substrate 202, a side column 221/222 and a middle column 223. The side column 221, the middle column 223 and the side column 222 are arranged in sequence and are arranged between the upper magnetic substrate 201 and the lower magnetic substrate 202. The substrate 10 comprises an upper surface 101, a lower surface 102 opposite to each other and holes 111/112/114, wherein holes 111/112/114 penetrating through the upper surface 101 and the lower surface 102 are used for allowing the side column 221, the middle column 223 and the side column 222 to penetrate through; the upper magnetic substrate 201 and the lower magnetic substrate 202 are respectively buckled the circuit substrate 100 from the upper surface 101 and the lower surface 102. The area between the hole 111 and the hole 112 is a first winding area 121 (equivalent to a channel between the side column 221 and the middle column 223); and the area between the holes 112 and 114 is a second winding area 122 (equivalent to a channel between the middle column 223 and the side column 222). The magnetic assembly 200 comprises a first side surface 211, a second side surface 212, a third side surface 213 and a fourth side surface 214, wherein the first side surface 211 and the third side surface 213 are opposite to each other, and the second side surface 212 is opposite to the fourth side surface 214. Here, the definition of the four side surfaces is not limited, it can take the definition in the other embodiments as reference. In the embodiment, the first side surface 211 and the third side surface 213 are located at the opening positions of the two sides of the first winding area 121 or the second winding area 122 respectively. A plurality of switches Q13 and Q14 of the primary circuit and a plurality of switches of the secondary circuit are disposed on the upper surface 101 of the circuit substrate. Switches SR11/SR13/SR18/SR16 of a first secondary full-bridge circuit are adjacent to a third side surface 213 of the magnetic assembly 200, and are sequentially arranged from left to right according to the order of SR11/SR13/SR18/SR16. The switches SR15/SR17/SR14/SR12 of the second secondary full-bridge circuit are adjacent to the first side surface 211 of the magnetic assembly 200, and are sequentially arranged from left to right according to the sequence of SR15/SR17/SR14/SR12. The lower switches Q13 and Q14 of the primary circuit are disposed adjacent to the second side surface 212. A plurality of switches Q11 and Q12 of the primary circuit and a plurality of switches of the secondary circuit are disposed on the lower surface 102 of the circuit substrate. In detail, switches SR11/SR13/S18/S16 on the lower surface 102 of the circuit substrate are adjacent to a third side surface 213 of the magnetic assembly 200, and are sequentially arranged from left to right according to the order of SR11/SR13/SR18/SR16, and are arranged in a one-to-one correspondence with switches SR11/SR13/SR18/SR16 disposed on the upper surface 101 of the circuit substrate. (The one-to-one correspondence setting means, the projection of the switch SR11 disposed on the upper surface 101 on the upper surface 101 at least partially overlaps with the projection of the switch SR11 disposed on the lower surface 102 on the upper surface 101. The one-to-one correspondence setting appearing below conforms to the definition.) The switches SR15/SR17/SR14/SR12 on the lower surface 102 of the circuit substrate are adjacent to the first side surface 211 of the magnetic assembly 200, and are sequentially arranged from left to right according to the order of SR15/SR17/SR14/SR12, and are arranged in one-to-one correspondence with switches SR15/SR17/SR14/SR12 arranged on the upper surface 101 of the circuit substrate. Compared with other side surfaces of the magnetic assembly 200, the upper switches Q11 and Q12 are arranged closer to the second side surface 212, and Q11 and Q12 are respectively in one-to-one correspondence with the lower switches Q13 and Q14 arranged on the upper surface 101 of the circuit substrate, the method has the advantages that the length of the short wiring of the midpoint of the bridge arm is the minimum, and the loop of the bridge arm is minimum. The input positive terminal Vin+, the input negative terminal Vin−, the output positive terminal Vo+ and the output negative terminal Vo− are all arranged on the lower surface 102. The input positive terminal Vin+ is arranged adjacent to the upper switches Q11 and Q12. The output positive terminal Vo+ and the output negative terminal Vo− are arranged adjacent to the fourth side surface 214. And the output capacitor is arranged on the outer side of the secondary side switch bridge arm switch, so that the power conversion device meets the output capacitor, the secondary side switch bridge arm switch, the magnetic assembly, the secondary side switch bridge arm switch and the output capacitor are arranged in sequence on the Y axis.

The power conversion device disclosed by the embodiment further comprises a control unit (not shown) and isolation driving units U1 and U2. The control unit uses the output negative terminal Vo− as the reference. The isolation driving unit U1/U2 is used for driving the isolation of the control signal, specifically, the isolation driving unit U1/U2 receives a control signal output by the control unit, and the isolation driving unit U1/U2 outputs a turn-on and turn-off signal for controlling the primary circuit switch. On the lower surface 102 of the circuit substrate, the isolation driving unit U1/U2 is located between the upper switch Q11/Q12 and the second side surface 212 of the magnetic assembly 200, so that the power conversion device meets the arrangement that the input positive terminal Vin+, the primary side switch bridge arm switch, the isolation driving unit U1/U2, the magnetic assembly, the output positive terminal Vo+ or the output negative terminal Vo− in sequence on the X axis.

The application further discloses a winding mode of the transformer winding, the winding mode of the primary winding TW11 is shown in FIG. 4E, and the winding mode of the secondary windings TW21 and TW22 is shown in FIG. 4F. Both ends of the primary winding TW11 are disposed adjacent to the same side of the magnetic assembly 200. In this embodiment, the two ends of the primary winding TW11 are disposed adjacent to the third side surface 213. The primary winding TW11 is wound around the middle column 223 in the third direction to form two circles, for example, in counterclockwise direction from the connecting point A to the midpoint B. a circle is wound around the middle column 223 in the third direction from the midpoint C to the midpoint D of the secondary winding TW21, for example, in counterclockwise direction from the midpoint C to the midpoint D; the midpoint C and the midpoint D are both arranged adjacent to the third side surface 213 and are respectively arranged adjacent to the first winding area 121 and the second winding area 122. The secondary winding TW22 is wound around the middle column 223 in a third direction from the midpoint E to the midpoint F to form a circle, for example, from the midpoint E to the midpoint F in a counterclockwise direction; the midpoint E and the midpoint F are both arranged close to the first side surface 211, and are respectively arranged adjacent to the second winding area 122 and the first winding area 121. In the embodiment, the two terminals of each secondary side winding are located on the same side of the magnetic core and are close to the opening positions of the same side of the first winding area 121 and the second winding area 122 respectively; and the terminals of the two secondary side windings are located on the two opposite sides of the magnetic assembly 200, respectively.

In the embodiment, the switching devices of the first secondary-side full-bridge circuit and the second secondary-side full-bridge circuit are arranged on the two opposite sides of the magnetic assembly 200, the switching devices of the first secondary-side full-bridge circuit is flush with the third side surface 213 of the magnetic assembly 200, and the switching devices of the second secondary-side full-bridge circuit is flush with the first side surface 211 of the magnetic assembly 200. Switches of the first secondary side switch bridge arm and the fourth secondary side switch bridge arm are arranged from left to right, and sequentially comprises an upper switch of a first secondary side switch bridge arm, a lower switch of a first secondary side switch bridge arm, a lower switch of a fourth secondary side switch bridge arm and an upper switch of a fourth secondary side switch bridge arm. The upper switch of the first secondary side switch bridge arm and the lower switch of the first secondary side switch bridge arm are connected in series to form a bridge arm midpoint C; the lower switch of the fourth secondary side switch bridge arm and the upper switch of the fourth secondary side switch bridge arm are connected in series to form a bridge arm midpoint D; and the source electrode of the lower switch of the first secondary side switch bridge arm is short-circuited with the source electrode of the lower switch of the fourth secondary side switch bridge arm. The third secondary side switch bridge arm and the second secondary side switch bridge arm are arranged from left to right, sequentially provided with an upper switch of the third secondary side switch bridge arm, a lower switch of the third secondary side switch bridge arm, a lower switch of the second secondary side switch bridge arm and an upper switch of the second secondary side switch bridge arm. The upper switch of the third secondary side switch bridge arm and the lower switch of the third secondary side switch bridge arm are connected in series to form a bridge arm midpoint F; the lower switch of the second secondary side switch bridge arm and the upper switch of the second secondary side switch bridge arm are connected in series to form a bridge arm midpoint E; and the source electrode of the lower switch of the third secondary side switch bridge arm is short-circuited with the source electrode of the lower switch of the second secondary side switch bridge arm.

In the embodiment, the winding method of the two secondary windings is matched with the layout method of the switching devices in the first secondary full-bridge circuit and the second secondary full-bridge circuit, so that the path of the secondary winding of the transformer is the shortest, the parasitic resistance of the winding is minimum, the number of switching devices in the secondary full-bridge circuit is doubled, and the conduction loss of the switching device is reduced.

### Embodiment 4

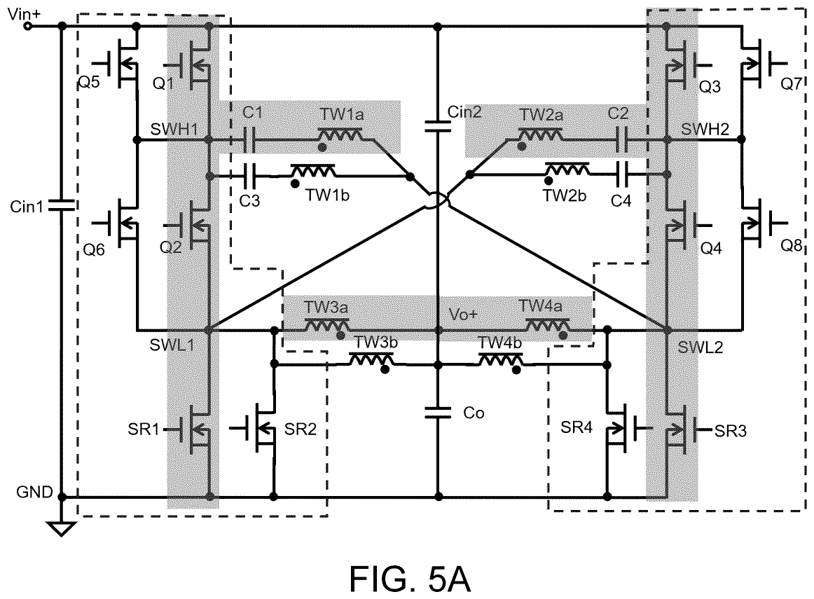

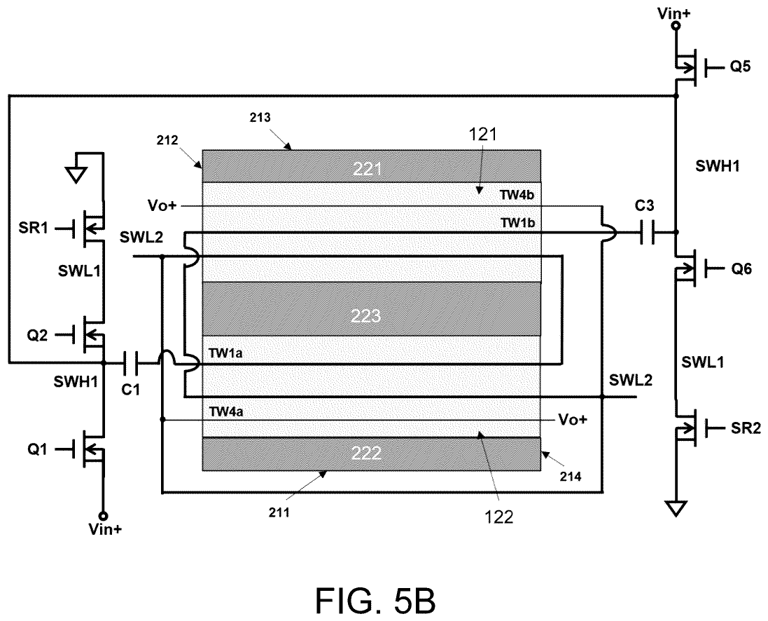

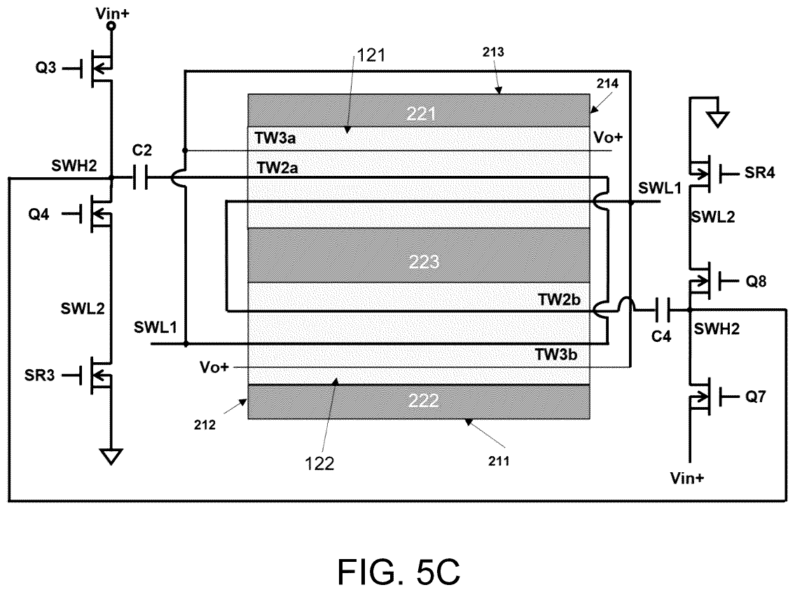

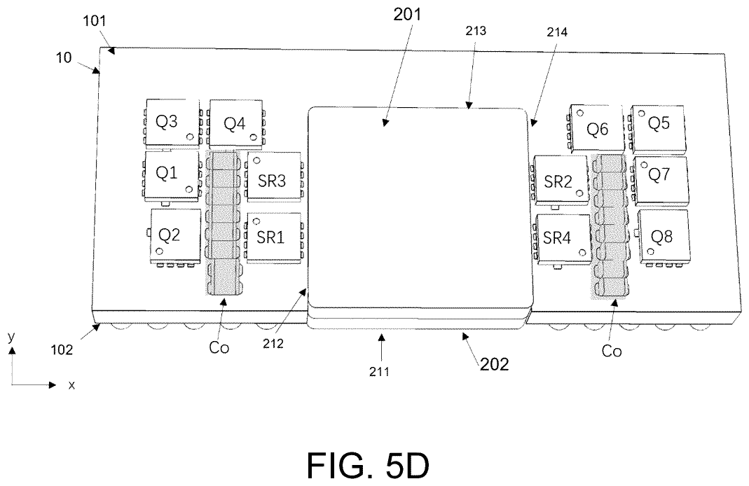

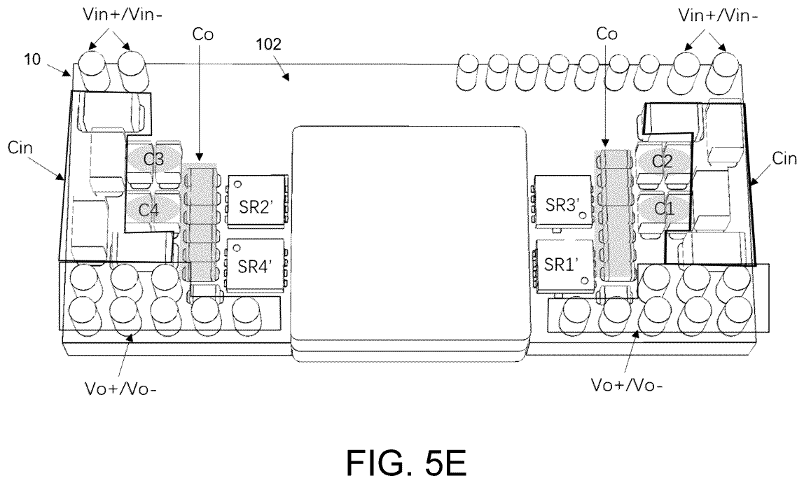

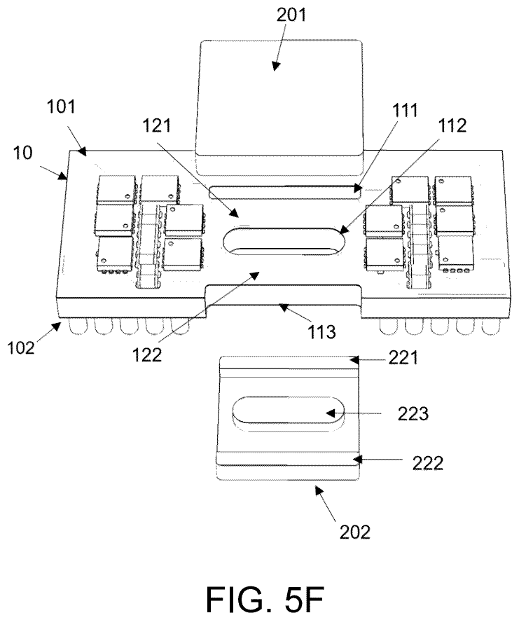

Another power conversion circuit topology is disclosed in this embodiment, as shown in FIG. 5A. The circuit topology disclosed by the embodiment is different from that shown in FIG. 1A. In embodiment 4, an upper switch Q5 and a middle switch Q6 are added on a first three-switch bridge arm (such as a dotted line frame in the figure), an upper switch Q7 and a middle switch Q8 are added on a second three-switch bridge arm (such as a dotted line frame in the figure), wherein the upper switch Q5 and the upper switch Q1 are connected in parallel, the middle switch Q6 and the middle switch Q2 are connected in parallel, the upper switch Q7 and the upper switch Q3 are connected in parallel, and the middle switch Q8 and the middle switch Q4 are connected in parallel; each high-voltage winding and the low-voltage winding are electrically connected in parallel by adopting two sub-windings. For example, the high-voltage winding TW1 comprises high-voltage sub-windings TW1a and TW1b, and the high-voltage winding TW2 comprises high-voltage sub-windings TW2a and TW2b; flying capacitors C3 and C4 are also added; and the second end of the flying capacitor C1 is electrically connected with the first end of the high-voltage sub-winding TW1a; a second end of the flying capacitor C3 is electrically connected to a first end of the high-voltage sub-winding TW1b; a first end of the flying capacitor C1 and a first end of the C3 are electrically connected to the first upper node SWH1; and the second end of the flying capacitor C2 is electrically connected with the first end of the high-voltage sub-winding TW2a; a second end of the flying capacitor C4 is electrically connected to a first end of the high-voltage sub-winding TW2b; a first end of the flying capacitor C2 and a first end of the C4 are electrically connected to the second upper node SWH2; a second end of the high-voltage sub-winding TW2a and a second end of the TW2b are electrically connected to the first lower node SWL1.

Specifically, the power change circuit topology shown in FIG. 5A comprises a first circuit unit and a second circuit unit, and the first circuit unit comprises a first three-switch bridge arm, a flying capacitor C1/C3, a high-voltage winding TW1a/TW1b and a low-voltage winding TW4a/TW4b; and the second circuit unit comprises a second three-switch bridge arm, a flying capacitor C2/C4, a high-voltage winding TW2a/TW2b and a low-voltage winding TW3a/TW3b. The number of semiconductor switching devices is doubled, the number of flying capacitors is doubled, the switching bridge arms still share one transformer, parasitic direct-current impedance on the semiconductor switching device is reduced, and lower loss and higher output power on the power conversion device are achieved. According to the embodiment, the control time sequences shown in Embodiment 1 can be adopted, and details are not described herein again.

FIG. 5B and FIG. 5C are winding modes of windings and connection with an external device. The magnetic core structure adopted in the embodiment is the same as the magnetic core structure shown in the above embodiments. The first three-switch bridge arm comprises a left bridge arm and a right bridge arm, the left bridge arm comprises an upper switch Q1, a middle switch Q3 and a lower switch SR1, the right bridge arm comprises an upper switch Q5, the middle switch Q6 and the lower switch SR2. The left bridge are arranged adjacent to the second side surface 212 of the magnetic core, and the right bridge arm is arranged adjacent to the fourth side surface 214 of the magnetic core; the lower switch SR1 of the left bridge arm is adjacent to the second side surface 212 of the magnetic core and is arranged adjacent to the first winding area 121; and the lower switch SR2 of the right bridge arm is adjacent to the fourth side surface 214 of the magnetic core and is arranged adjacent to the second winding area 122, that is, the lower switch SR1 and the lower switch SR2 are respectively arranged on the opposite side edges of the magnetic core along the diagonal lines of the magnetic core. The high-voltage sub-winding TW1a, from the first end to the second end, passes through the second winding area 122 in the first direction (i.e., from left to right), is wound along the fourth side surface 214, passes through the first winding area 121 in the second direction (i.e., from right to left), and reaches the second end (i.e., the SWL2 network adjacent to the second side surface 212 and the first winding area 121). The high-voltage sub-winding TW1b, from the first end to the second end, first passes through the first winding area 121 in the second direction, is wound along the second side surface 212, passes through the second winding area 122 in the first direction, and reaches the second end (i.e., the SWL2 network adjacent to the fourth side surface 214 and the second winding region 122). The SWL2 network adjacent to the second side surface 212 and the SWL2 network adjacent to the fourth side surface 214 are electrically connected through wiring, so that the SWL2 network surrounds at least a half circle of the magnetic core; in the embodiment, the SWL2 network is electrically connected through the wiring along the first side surface 211 of the magnetic core, but is not limited thereto, and the wiring can also be arranged along the third side surface 213 of the magnetic core. The first upper node SWH1 of the left bridge arm and the first upper node SWH1 of the right bridge arm are also electrically connected through wiring on the outer side of the magnetic core to form an SWH1 network. The flying capacitor C1 is arranged adjacent to the first end of the high-voltage sub-winding TW1a and is electrically connected with the adjacent SWH1 network; and the flying capacitor C3 is arranged adjacent to the first end of the high-voltage sub-winding TW1b and is electrically connected with the adjacent SWH1 network. The low-voltage sub-winding TW4a starts from a first end (i.e., an SWL2 network adjacent to the second side surface 212 and the second winding area 122), passes through the second winding region 122 to the second end in a first direction (i.e., a Vo+ network adjacent to the fourth side surface 214 and the second winding area 122); a low-voltage sub-winding TW4b starting from a first end (i.e., an SWL2 network adjacent to the fourth side surface 214 and the first winding area 121), passing through the first winding area 121 to the second end in a second direction (i.e., a Vo+ network adjacent to the second side surface 212 and the first winding area 121); in the embodiment, each high-voltage sub-winding is wound for one turn, and each low-voltage sub-winding is wound with 0.5 turn.

The second three-switch bridge arm also comprises a left bridge arm and a right bridge arm, the left bridge arm comprises an upper switch Q3, a middle switch Q4 and a lower switch SR3, the right bridge arm comprises an upper switch Q7, the middle switch Q8 and the lower switch SR4. The left bridge arm is arranged adjacent to the second side surface 212 of the magnetic core, and the right bridge arm is arranged adjacent to the fourth side surface 214 of the magnetic core; the lower switch SR3 of the left bridge arm is adjacent to the second side surface 212 of the magnetic core and is arranged adjacent to the second winding area 122, the lower switch SR4 of the right bridge arm is adjacent to the fourth side surface 214 of the magnetic core and is arranged adjacent to the first winding area 121, namely the lower switch SR3 and the lower switch SR4 are respectively arranged on the opposite side edges of the magnetic core along the diagonal lines of the magnetic core. The high-voltage sub-winding TW2a, from the first end to the second end, passes through the first winding area 121 in the first direction, is wound along the fourth side surface 214, passes through the second winding area 122 in the second direction, and reaches the second end (i.e., the SWL1 network adjacent to the second side surface 212 and the second winding area 122). The high-voltage sub-winding TW2b, from the first end to the second end, passes through the second winding area 122 in the second direction, is wound along the second side surface 212, passes through the first winding area 121 in the first direction, and reaches the second end (i.e., the SWL1 network adjacent to the fourth side surface 214 and the first winding area 121). The SWL1 network adjacent to the second side surface 212 and the SWL1 network adjacent to the fourth side surface 214 are electrically connected through wiring, so that the SWL1 network surrounds at least half circles of the magnetic core; in the embodiment, the SWL1 network is electrically connected through the wiring along the third side surface 213 of the magnetic core, but is not limited thereto, and the wiring can also be arranged along the first side surface 211 of the magnetic core. The second upper node SWH2 of the left bridge arm and the second upper node SWH2 of the right bridge arm are also electrically connected through wiring on the outer side of the magnetic core to form an SWH2 network. The flying capacitor C2 is arranged adjacent to the first end of the high-voltage sub-winding TW2a and is electrically connected with the adjacent SWH2 network; and the flying capacitor C4 is arranged adjacent to the first end of the high-voltage sub-winding TW2b and is electrically connected with the adjacent SWH2 network. The low-voltage sub-winding TW3a starts from a first end (i.e., an SWL1 network adjacent to the second side surface 212 and the first winding area 121), passes through the first winding area 121 to the second end in a first direction (i.e., a Vo+ network adjacent to the fourth side surface 214 and the first winding area 121); the low-voltage sub-winding TW3b starts from the first end (i.e., the SWL1 network adjacent to the fourth side surface 214 and the second winding area 121) and passes through the second winding area 122 to the second end (i.e., the Vo+ network adjacent to the second side surface 212 and the second winding area 122) in the second direction; in the embodiment, each high-voltage sub-winding is wound for one turn, and each low-voltage sub-winding is wound with 0.5 turn.

Meanwhile, in combination with FIG. 5A to 5C, the circuit topology shown in FIG. 5A can also be regarded as two six-switch circuits connected in parallel, a first six-switch circuit is arranged in the gray area, and the rest is a second six-switch circuit (without the input capacitor and the output capacitor). A switch in the first six-switch circuit is arranged on the left side of the magnetic core, and a switch in the second six-switch circuit is arranged on the right side of the magnetic core. In combination with the winding mode of the high-voltage winding and the low-voltage winding, the first six-switch circuit and the second six-switch circuit take the magnetic core as the center and meet the left-right mirror image symmetry. In the embodiment, the magnetic core is still the magnetic core structure of the two winding areas of the three-magnetic column, the number of the switches and the number of the resonant capacitor/output capacitor/input capacitor are doubled, but the output power of the power conversion device is doubled through reasonable layout and winding modes of the winding, but the volume of the magnetic core is not changed, so that higher power density is obtained, and further, lower power loss is obtained by reducing parasitic parameters in the power conversion device. In the embodiment, the voltage drop across each flying capacitor is Vin/2, the turn ratio between the high-voltage winding and the low-voltage winding is 2:1; with the matched the duty ratio of the control signal, the output voltage Vo=Vin/8 can be obtained, that is, the ratio of the input voltage to the output voltage is 8:1.

FIG. 5D shows a schematic diagram of a top surface layout of the power conversion device, FIG. 5E shows a schematic diagram of a bottom surface layout of the power conversion device, and FIG. 5F shows an exploded view of the power conversion device. Referring to FIG. 5D to FIG. 5F, the power conversion device comprises a substrate 10, the substrate 10 comprises a top surface 101 and a bottom surface 102 opposite to each other, and further comprises a hole 111/112 and a hole groove 113, the hole 111/112 and the hole groove 113 penetrate through the top surface 101 and the bottom surface 102, and for the magnetic columns 221/223/222 respectively pass through; the substrate is buckled with the upper magnetic substrate 201 and the lower magnetic substrate 202; the area between the hole 111 and the hole 112 is a first winding area 121; and the area between the hole 112 and the hole groove 113 is a second winding area 122.

As shown in the top surface layout diagram shown in FIG. 5D, switches Q1/Q2/SR1/Q3/Q4/SR3 in the first six-switch circuit are arranged on the left side of the magnetic core, namely, adjacent to the second side surface 212 of the magnetic core; and switches Q5/Q6/SR2/Q7/Q8/SR4 in the second six-switch circuit are arranged on the right side of the magnetic core, namely, adjacent to the fourth side surface 214 of the magnetic core. The lower switches SR1 and SR3 are respectively arranged adjacent to the second winding area 122 and the first winding area 121, and the lower switches SR2 and SR4 are arranged adjacent to the first winding area 121 and the second winding area 122 respectively, so that the lower switch is arranged close to the first end of the corresponding low-voltage winding, and the power loss of the current flowing through the path is reduced. The output capacitor Co is respectively arranged between the lower switch and the upper switch. The lower switch SR1 of the left bridge arm of the first three-switch bridge arm and the lower switch SR2 of the right bridge arm of the first three-switch bridge arm are arranged along the diagonal line of the magnetic core and are respectively arranged on two opposite side surfaces of the magnetic core; and the lower switch SR3 of the left bridge arm of the second three-switch bridge arm and the lower switch SR4 of the right bridge arm of the second three-switch bridge arm are arranged along the other diagonal line of the magnetic core and are respectively arranged on two opposite side surfaces of the magnetic core. The upper switch of the left bridge arm of the first three-switch bridge arm and the upper switch of the left bridge arm of the second three-switch bridge arm are adjacently arranged, that is, the drains of the two upper switches are adjacent and short-circuited; the upper switch of the right bridge arm of the first three-switch bridge arm and the upper switch of the right bridge arm of the second three-switch bridge arm are adjacently arranged, that is, the drains of the two upper switches are adjacent and short-circuited. The center line in the Y direction of the magnetic core 201 is taken as the axis. The placement positions of the switches and the output capacitors of the first six-switch circuit on the left side of the magnetic core and the placement positions of the switches and the output capacitors of the second six-switch circuit on the right side of the magnetic core meet mirror symmetry.

As shown in the bottom surface layout diagram shown in FIG. 5E, the power conversion device further comprises lower switches SR1′/SR2′/SR3′/SR4′and are respectively arranged in parallel with the lower switch SR1/SR2/SR3/SR4, and each lower switch SR1′/SR2′/SR3′/SR4′ is arranged in one-to-one correspondence with the corresponding lower switch SR1/SR2/SR3/SR4, wherein the one-to-one correspondence arrangement means that the projection of the switch arranged on the top surface and the projection of the switch arranged on the bottom surface at least partially coincide on the top surface of the substrate; for example, the lower switches SR1 and SR1′ are arranged in a one-to-one correspondence manner, and are electrically connected in parallel through the via holes and/or the wirings arranged in the substrate. The output capacitor Co is arranged adjacent to the source electrode of the lower switch, and the lower switch is arranged between the output capacitor and the magnetic core. The flying capacitors C1/C2/C3/C4 are respectively adjacent to an upper switch and a middle switch in the same bridge arm. The power conversion device further comprises an input capacitor Cin, an input terminal Vin+/Vin− and an output terminal Vo+/Vo−; the input capacitor Cin and the input terminal Vin+/Vin− are arranged close to the upper switch; and the output terminal is adjacent to the output capacitor Co and/or the lower switch. The input terminal Vin+/Vin−, the input capacitor Cin, the output terminal Vo+/Vo− are arranged in sequence along the Y-axis. In the power conversion device disclosed by the embodiment, the first six-switch circuit and the second six-switch circuit are symmetrically arranged along the magnetic core, preferably, each device in the two six-switch circuits is symmetrically arranged along the magnetic core, so that the performance of the power conversion device is further optimized. Specifically, the center line of the magnetic core 201 in the Y direction is taken as the axis, the placement positions of the lower switch of the first six-switch circuit, the output capacitor, the flying capacitor and the input capacitor on the left side of the magnetic core, and the placement positions of the lower switch of the second six-switch circuit, the output capacitor, the flying capacitor and the input capacitor on the right side of the magnetic core meet the mirror symmetry. Furthermore, the center line of the magnetic core 201 in the Y direction is taken as the axis, the placement position of the input terminal Vin+/Vin− in the left side of the magnetic core and the placement position of the input terminal Vin+/Vin− on the right side of the magnetic core meet mirror symmetry; and the placement position of the output terminal Vo+/Vo− in the left side of the magnetic core and the placement position of the output terminal Vo+/Vo− on the right side of the magnetic core are in mirror symmetry by taking the center line in the Y direction of the magnetic core 201 as the axis.

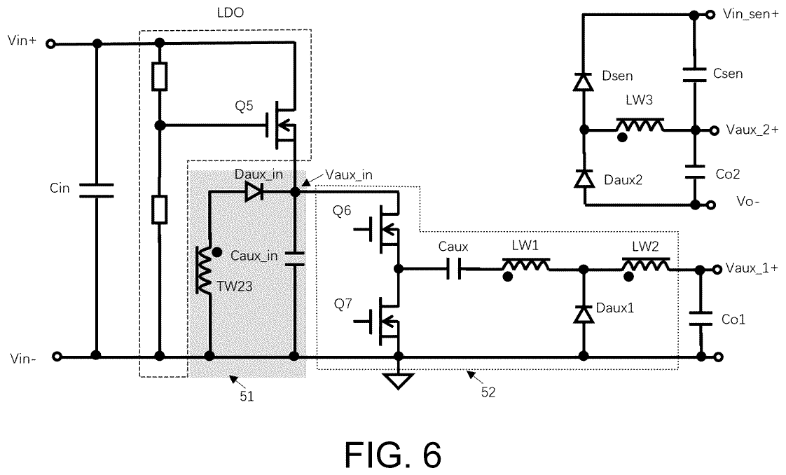

The embodiment also discloses an auxiliary power supply circuit, as shown in FIG. 6. An input terminal of the auxiliary power supply circuit is connected in parallel with the input terminals of FIG. 1A and FIG. 4A. The auxiliary power supply circuit further comprises an input capacitor Cin, an LDO circuit, an input circuit 51, a step-down circuit 52, a first auxiliary output Vaux_1 and an auxiliary output capacitor Co1, wherein the voltage of the first auxiliary output Vaux_1 is the voltage between the first auxiliary output positive terminal Vaux_1+ and the input negative terminal Vin−. The first end of the LDO is connected with the input positive terminal Vin+, the second end of the LDO is connected with the input negative terminal Vin−, and the third end of the LDO is electrically connected with the input circuit 51 and the step-down circuit 52 to the auxiliary input connection point Vaux_in. The input circuit 51 includes an auxiliary input winding TW23, an auxiliary input diode Daux_in, and an auxiliary input capacitor Caux_in. The auxiliary input winding TW23 and the auxiliary input diode Daux_in are connected in series and bridged between the auxiliary input connection point Vaux_in and the input negative terminal Vin−; and the auxiliary input capacitor Caux_in is bridged between the auxiliary input connection point Vaux_in and the input negative terminal Vin−. The positive electrode of the auxiliary input diode Daux_in is electrically connected with the first end of the auxiliary input winding TW23, and the negative electrode of the auxiliary input diode Daux_in is electrically connected with the auxiliary input connection point Vaux_in. The auxiliary input winding TW23 is coupled to a winding of a transformer of the power conversion circuit shown in FIG. 4A, and is wound around the center column 223 of the magnetic assembly 200, and the number of windings wound is also designed according to actual requirements. The first end of the auxiliary input winding TW23 and the point end of the transformer winding are same polarity ends, and are also labeled as point ends.

When the power conversion device is started, the step-down circuit 52 receives power supply from the LDO, and the voltage of the first auxiliary output Vaux_1 is established; and when the power conversion device enters the steady-state work, the auxiliary input winding TW23 coupled with the power transformer starts to supply power to the step-down circuit 52. The step-down circuit 52 comprises a switch Q6/Q7, an auxiliary output winding LW1, an auxiliary step-down capacitor Caux and a first auxiliary output circuit. The first auxiliary output circuit comprises an auxiliary output winding LW2, the auxiliary output diode Daux1 switches Q6 and Q7 are connected in series to form an auxiliary half-bridge switch bridge arm, and the auxiliary half-bridge switch bridge arm is bridged between the auxiliary input connection point Vaux_in and the input negative terminal Vin−; and the source electrode of Q6 and the drain electrode of Q7 are short-circuited to form the midpoint of the auxiliary half-bridge switch bridge arm. And the auxiliary output windings LW1 and LW2 are sequentially connected in series between the midpoint of the auxiliary half-bridge switch bridge arm and the first auxiliary output positive terminal Vaux_1+, and the first end of the auxiliary step-down capacitor Caux is electrically connected with the midpoint of the auxiliary half-bridge switch bridge arm, and the second end is electrically connected with the first end of the auxiliary output winding LW1; the second end of the auxiliary output winding LW1 is electrically connected with the first end of the auxiliary output winding LW2; and the second end of the auxiliary output winding LW2 is electrically connected with the first auxiliary output positive terminal Vaux_1+. The auxiliary output windings LW1 and LW2 are wound on a magnetic column of the same auxiliary transformer magnetic core; and the first end of the auxiliary output winding LW1 and the first end of the auxiliary output winding LW2 are same polarity ends and are labeled as point ends. The auxiliary output capacitor Col is bridged between the first auxiliary output positive terminal Vaux_1+ and the input negative terminal Vin−. In the present embodiment, the auxiliary power supply circuit further comprises a controller (not shown) for controlling the turn-on and turn-off of the buck switches Q6 and Q7 by sampling the first auxiliary output voltage Vaux_1, thereby obtaining a stable first auxiliary output voltage.

In the embodiment, through the cooperation of the LDO and the input circuit 51, the amplitude of the voltage received by the step-down circuit 52 can be greatly reduced, the duty ratio of the switch Q6 is increased, and the current flowing through the auxiliary output winding LW2 is close to the continuous current. The turn ratio of the auxiliary output windings LW1 to LW2 is K1, namely K1=Nlw1/Nlw2. When the auxiliary diode Daux1 is turned on, that is, when the step-down switch Q7 is turned on, the voltage at the two ends of the auxiliary output winding LW2 is Vaux_1, and the voltage at the two ends of the output winding LW1 is K1*Vaux_1, that is, the voltage V_Caux=K1*Vaux_1 at the two ends of the auxiliary step-down capacitor Caux is equal to K1*Vaux_1 according to the volt-second balance of the inductor, and the volt-second balance expression after the auxiliary output windings LW1 and LW2 are connected in series can be obtained,

[Vaux_in−Vaux_1*(1+K1)]*Duty=Vaux_1*(1+K1)*(1−Duty) (1)

The duty ratio of the step-down switch Q6: Duty=Vaux_1*(1+K1)/Vaux_in (2)

Compared with the duty ratio D_buck=Vaux_1/Vaux_in of a traditional BUCK circuit, when K1=1, the duty of the auxiliary power supply circuit is twice that of D_buck, so that the duty cycle of the switch Q6 is doubled. When K1>1, the duty of the auxiliary power supply circuit is more than 2 times of D_buck, so that the current flowing through the auxiliary output winding LW2 is in a continuous state, that is, the auxiliary power supply circuit works in a continuous conduction mode CCM (Continuous Conduction Mode).

Furthermore, the auxiliary power supply circuit further comprises a second auxiliary output circuit which comprises an auxiliary output winding LW3, an auxiliary output diode Daux_2, a second auxiliary output Vaux_2 and an auxiliary output capacitor Co2, wherein the voltage of the second auxiliary output Vaux_2 is the voltage across the second auxiliary output positive terminal Vaux_2+ and the output negative terminal Vo−. The first end of the auxiliary output winding LW3 is electrically connected with the negative electrode of the auxiliary diode Daux_2, the positive electrode of the auxiliary diode Daux_2 is electrically connected with the output negative terminal Vo−, and the second end of the auxiliary output winding LW3 is electrically connected with the second auxiliary output positive terminal Vaux_2+. The auxiliary output capacitor Co2 is bridged between the second auxiliary output positive terminal Vaux_2+ and the input negative terminal Vin−. The auxiliary output winding LW3 is coupled with LW1 and LW2 and is wound around the same magnetic column of the auxiliary transformer magnetic core. A first end of the auxiliary output winding LW3 and a first end of the auxiliary output winding LW1 and a first end of the LW2 are same polarity ends and are marked as point ends. The turn ratio K2 of the auxiliary output windings LW3 and LW2, K2=Nlw3/Nlw2, and the turn ratio K3=Nlw3/(Nlw1+Nlw2) is defined. In the present embodiment, since the current flowing through the auxiliary output winding LW2 is a continuous current, the ratio of Vaux_2 to Vaux_1 is approximately equal to K2 (the “approximation” herein indicates that the ratio is in the range of K2 +/−10%.) Therefore, the voltage stabilization precision of the second auxiliary output voltage Vaux_2 is higher.

Furthermore, the auxiliary power supply circuit disclosed by the embodiment further comprises an input voltage sampling output which comprises a sampling diode Dsen, a sampling capacitor Csen and a sampling output VIN_sen; the positive electrode of the sampling diode Dsen is electrically connected with the first end of the auxiliary output winding LW3, and the negative electrode is electrically connected with the sampling output positive terminal Vin_sen+. A capacitor Csen is connected between a sampling output positive terminal Vin_sen+ and a second auxiliary output positive terminal Vaux_2+. The sampling output voltage Vin_sen is the voltage difference between the positive terminal Vin_sense+ voltage and the output negative terminal Vo−, and the power conversion device can still complete sampling and monitoring of the power input voltage Vin on the power output voltage side; and the voltage between Vin_sen+ and the output negative terminal Vo− is close to Vaux_1*K2+[Vaux_in−Vaux_1*(1+K1)]*K3. Since the current flowing through the auxiliary output winding LW2 is a continuous current, the voltage precision of the sampling output Vin_sen is not affected by the voltage amplitude of the Vaux_in, and is not affected by the load size of the Vaux_1.

The auxiliary power supply circuit disclosed by the embodiment is not only suitable for the power circuit topology shown in FIG. 1A and FIG. 4A, as long as the voltage difference between the input voltage of the power conversion device and the auxiliary power supply output voltage is large, so that the auxiliary power supply circuit applying the traditional BUCK circuit works in the DCM (Discontinuous Conduction Mode), and the problem of current interruption can be solved by using part of circuits or all circuits of the auxiliary power supply circuit shown in FIG. 6; so that the cross regulation rate between the multiple output voltages of the auxiliary power supply circuit can be met, and the precision of the input voltage detected on the output side can be improved.

The switch tube disclosed by the application can be used for realizing the functions of the switch disclosed by the application, such as a Si MOSFET, SiC MOSFET, GaN MOSFET or IGBT MOSFET.

The power conversion device according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/− 30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion device, comprising:
an input end, an output end, a first switch bridge arm, a second switch bridge arm, a first flying capacitor, a second flying capacitor, an output capacitor, and a magnetic assembly;
wherein the input end comprises an input positive terminal and an input negative terminal, and the output end comprises an output positive terminal and an output negative terminal;
wherein the first switch bridge arm comprises a first upper switch, a first middle switch and a first lower switch which are sequentially connected in series; wherein the first upper switch and the first middle switch are connected in series to the first upper node, the first middle switch and the first lower switch are connected in series to a first lower node;
wherein the second switch bridge arm comprises a second upper switch, a second middle switch and a second lower switch which are sequentially connected in series; wherein the second upper switch and the second middle switch are connected in series to a second upper node, and the second middle switch and the second lower switch are connected in series to a second lower node;
wherein the magnetic assembly comprises a first side surface, a second side surface, a third side surface and a fourth side surface, the first side surface and the third side surface are opposite, and the second side surface and the fourth side surface are opposite; the first middle switch, the first upper switch, the second upper switch and the second middle switch are sequentially arranged close to the second side surface; the first lower switch and the second lower switch are arranged between the fourth side surface and the output capacitor;
wherein the magnetic assembly further comprises a magnetic core, a first primary winding, a second primary winding, a first secondary winding and a second secondary winding; the first end and the second end of the first primary winding, and the first end and the second end of the second primary winding are arranged close to the second side surface; the first end and the second end of the first secondary winding, and the first end and the second end of the second secondary winding are arranged close to the fourth side surface;
wherein the first flying capacitor and the second flying capacitor are disposed adjacent to the second side surface; wherein the first flying capacitor is bridged between the first upper node and the first end of the first primary winding, and the second end of the first primary winding is electrically connected with the second lower node; wherein the second flying capacitor is bridged between the second upper node and the first end of the second primary winding, and the second end of the second primary winding is electrically connected with the first lower node.

2. The power conversion device of claim 1, further comprising:
a circuit substrate and an input capacitor;
wherein the circuit substrate comprises an upper surface and a lower surface which are opposite to each other;
the first upper switch, the second upper switch, the first middle switch, the second middle switch, the first lower switch, the second lower switch and part of the output capacitors are arranged on the upper surface;
the input capacitor, the first flying capacitor, the second flying capacitor, and the other part of the output capacitors are arranged on the lower surface;
the input capacitor is bridged at the input end, and the output capacitor is bridged at the output end.

3. The power conversion device of claim 2, wherein the magnetic core comprises three magnetic columns and two magnetic substrates, the three magnetic columns are arranged between the two magnetic substrates, and the magnetic columns are respectively a first side column, a middle column and a second side column; the circuit substrate comprises three holes, or two holes and a hole groove, and the magnetic columns penetrate through the holes or the hole grooves respectively;
wherein the circuit substrate further comprises a first winding area and a second winding area, the first winding area is arranged between the first side column and the middle column, and the second winding area is arranged between the second side column and the middle column;
the first winding area and the second winding area penetrate through the second side surface and the fourth side surface; the first end of the first primary winding is electrically connected with a first flying capacitor, the second end of the first primary winding is electrically connected with a second lower node, and the first primary winding winds a circle around the middle column and the second side column in the clockwise direction; the first end of the second primary winding is electrically connected with a second flying capacitor, the second end of the second primary winding is electrically connected with a first lower node, and the second primary winding winds the middle column and the first side column in the anticlockwise direction for a circle;
the first end of the first secondary side winding is electrically connected with a first lower node, the second end of the first secondary side winding is electrically connected with the positive electrode of the output capacitor, and the first secondary side winding winds a circle around the middle column in the anticlockwise direction;
the first end of the second secondary side winding is electrically connected with a second lower node, the second end of the second secondary side winding is electrically connected with the positive electrode of the output capacitor, and the second secondary side winding winds a circle around the middle column in the clockwise direction.

4. The power conversion device of claim 3, wherein a first end of the first high-voltage winding, a second end of the second high-voltage winding, a second end of the first secondary winding, and a first end of the second secondary winding are dotted terminals.

5. The power conversion device of claim 2, further comprising:
another first lower switch and another second lower switch, wherein the other first lower switch and the other second lower switch are arranged on the lower surface of the circuit substrate;
the first lower switch and the other first lower switch are arranged in a one-to-one correspondence mode, and the second lower switch and the other second lower switch are arranged in a one-to-one correspondence mode.

6. The power conversion device of claim 5, wherein the power consumption of the other first lower switch is 35%-65% of the power consumption of the first lower switch, and the power consumption of the other second lower switch is 35%-65% of the power consumption of the second lower switch.

7. The power conversion device of claim 3, wherein the input capacitor comprises a first input capacitor and a second input capacitor, the first input capacitor is bridged between the input positive terminal and the input negative terminal, and the second input capacitor is bridged between the input positive terminal and the output positive terminal.

8. The power conversion device of claim 7, wherein the short wiring of the first high-voltage winding located on the first side surface and the short wiring between the second input capacitor and the output positive terminal are laid in a staggered mode, or the short wiring of the first high-voltage winding located on the first side surface and the short wires between the first input capacitor and the output negative terminal are laid in a staggered mode;
the short wiring of the second high-voltage winding located on the third side surface and the short wiring between the second input capacitor and the output positive terminal are laid in a staggered mode or the short wiring of the second high-voltage winding located on the third side surface and are staggered with the short wiring between the first input capacitor and the output negative terminal.

9. The power conversion device of claim 2, wherein the first flying capacitor, the input capacitor and the second flying capacitor are sequentially arranged on the bottom surface;
the first flying capacitor is arranged adjacent to the first side surface, and the second flying capacitor is arranged adjacent to the second side surface.

10. The power conversion device of claim 1, wherein the input capacitor comprises the first input capacitor and the second input capacitor,
wherein the first input capacitor is bridge-connected between the input positive terminal and the input negative terminal, and the second input capacitor is bridge-connected between the input positive terminal and the output positive terminal.

11. A power conversion device, comprising:
a first six-switch circuit, a second six-switch circuit, a magnetic core, and a substrate,
wherein the magnetic core is arranged on the substrate; and the magnetic core comprises a first side surface and a third side surface which are opposite to each other, and an opposite second side surface and a fourth side surface;
the first six-switch circuit is arranged adjacent to the second side surface of the magnetic core, and the second six-switch circuit is arranged adjacent to the fourth side surface of the magnetic core;
each six-switch circuit comprises a first three-switch bridge arm and a second three-switch bridge arm, and each three-switch bridge arm comprises an upper switch, a middle switch and a lower switch which are electrically connected in series.

12. The power conversion device of claim 11, wherein a lower switch in the first six-switch circuit and a lower switch in the second six-switch circuit are in mirror symmetry along the Y-direction center line of the magnetic core.

13. The power conversion device of claim 12, wherein the upper switch of the first three-switch bridge arm in each six-switch circuit are electrically connected in parallel, and the upper switch of the second three-switch bridge arm in each six-switch circuit are electrically connected in parallel;
the middle switch of the first three-switch bridge arm in each six-switch circuit are electrically connected in parallel, and the middle switch of the second three-switch bridge arm in each six-switch circuit are electrically connected in parallel; and the lower switch of the first three- switch bridge arm in each six-switch circuit are electrically connected in parallel, and the lower switch of the second three-switch bridge arm in each six-switch circuit are electrically connected in parallel.

14. The power conversion device of claim 12, wherein the power conversion device further comprises an output capacitor,
the output capacitor is arranged adjacent to the second side surface and the fourth side surface of the magnetic core respectively, and the output capacitor arranged adjacent to the second side surface of the magnetic core and the output capacitor arranged on the fourth side surface of the magnetic core are in mirror symmetry along the Y-direction center line of the magnetic core.

15. The power conversion device of claim 12, wherein the power conversion device further comprises an input capacitor, an input terminal, and an output terminal;
the input capacitor, the input terminal and the output terminal are respectively arranged adjacent to the second side surface and the fourth side surface of the magnetic core; and
the input terminal, the input capacitor and the output terminal are sequentially arranged in the Y direction of the magnetic core.

16. The power conversion device of claim 12, wherein the power conversion device further comprises a Vo+ network, a GND network, and an output terminal;
the output terminal comprises an output positive terminal and an output negative terminal;
the Vo+ network is electrically connected with the output positive terminal, and the GND network is electrically connected with the output negative terminal; and
the Vo+ network and the GND network are both arranged on the substrate and surround one circle of the magnetic core.

17. The power conversion device of claim 12, wherein the middle switch in the first six-switch circuit and the middle switch in the second six-switch circuit are in mirror symmetry along the Y-direction center line of the magnetic core; and the upper switch in the first six-switch circuit and the upper switch in the second six-switch circuit are in mirror symmetry along the Y-direction center line of the magnetic core.

18. The power conversion device of claim 13, wherein the upper switch and the middle switch of the first three-switch bridge arm in each six-switch circuit are electrically connected to the first upper node, and the middle switch and the lower switch of the first three-switch bridge arm in each six-switch circuit are electrically connected to the first lower node;
the upper switch and the middle switch of the second three-switch bridge arm in each six-switch circuit are electrically connected to the second upper node, and the middle switch and the lower switch of the second three-switch bridge arm in each six-switch circuit are electrically connected to the second lower node; the wirings of the first upper node and the second upper node on the substrate are arranged along the first side surface or the third side surface of the magnetic core; and
the wirings of the first lower node and the second lower node on the substrate is arranged along the third side surface or the first side surface of the magnetic core.

19. The power conversion device of claim 17, wherein each six-switch circuit comprises a first flying capacitor, a second flying capacitor, a first high-voltage winding, a second high-voltage winding, a first low-voltage winding, and a second low-voltage winding;
the first flying capacitor and the first high-voltage winding are electrically connected in series and bridged between the first upper node and the second lower node, the first end of the first high-voltage winding is electrically connected with the first flying capacitor, and the second end of the first high-voltage winding is electrically connected with the second lower node;
the second flying capacitor and the second high-voltage winding are electrically connected in series and are bridged between the second upper node and the first lower node, the first end of the second high-voltage winding is electrically connected with the second flying capacitor, and the second end of the second high-voltage winding is electrically connected with the first lower node; the first end of the first low-voltage winding is electrically connected with a first lower node, and the second end of the first low-voltage winding is electrically connected with the output positive terminal;
the first end of the second low-voltage winding is electrically connected with a second lower node, and the first end of the second low-voltage winding is electrically connected with the output positive terminal; and
the first end of the first high-voltage winding, the second end of the second high-voltage winding, the second end of the first low-voltage winding and the first end of the second low-voltage winding are the dotted terminals.

20. The power conversion device of claim 19, wherein the magnetic core comprises a first side column, a middle column, and a second side column;
the first side column, the middle column and the second side column are sequentially arranged in the same direction;
a first winding area is arranged between the first side column and the middle column, and a second winding area is arranged between the second side column and the middle column;
the first high-voltage winding and the second high-voltage winding in the same six-switch circuit are wound around the middle column by a circle and the winding direction from the first end to the second end of the first high-voltage winding is opposite to the winding direction from the first end to the second end of the second high-voltage winding; and
the first low-voltage winding and the second low-voltage winding in the same six-switch circuit penetrate through the first winding area and the second winding area respectively, and the direction of the first low-voltage winding passing through the winding area from the first end to the second end is the same as the direction of each high-voltage winding from the first end to the second end penetrating through the same winding area.

21. The power conversion device of claim 12, wherein each device in the first six-switch and corresponding devices in the second six-switch circuit are in mirror symmetry along the Y-direction center line of the magnetic core.

22. A power conversion device, comprising:
a high-voltage switch, a high-voltage winding, a low-voltage switch, a low-voltage winding, a magnetic core, and a substrate,
wherein the magnetic core is arranged on the substrate;
the magnetic core comprises a first side surface and a third side surface which are opposite to each other, and an opposite second side surface and a fourth side surface; the high-voltage switch is arranged adjacent to the third side surface of the magnetic core; the low-voltage switch is arranged adjacent to the second side surface and the fourth side surface of the magnetic core;
the magnetic core comprises a first side column, a middle column and a second side column; the first side column, the middle column and the second side column are sequentially arranged in the same direction; the high-voltage winding and low-voltage winding are separately wound around the middle column for a circle.

23. The power conversion device of claim 22, wherein a first winding area is arranged between the first side column and the middle column, and a second winding area is arranged between the second side column and the middle column;
the first winding area and the second winding area penetrate the second side surface and the fourth side surface, and opening of winding areas are formed on the second side surface and the fourth side surface;
the low-voltage switch is arranged close to the openings of winding areas.

24. The power conversion device of claim 23, wherein the circuit substrate comprises hole and hole groove, and the magnetic columns penetrate through the holes and/or the hole grooves respectively;
the magnetic core further comprises an upper magnetic substrate and a lower magnetic substrate, and the upper magnetic substrate and the lower magnetic substrate are buckled the substrate from the upper surface and the lower surface respectively; the windings are disposed in the substrate.

25. The power conversion device of claim 22, further comprising:
an input positive terminal and an input negative terminal, an output positive terminal, and an output negative terminal;
wherein the high-voltage switch comprises a first upper switch, a second upper switch, a first middle switch, and a second middle switch;
the first upper switch is bridge-connected between the input positive terminal and a first upper end;
the first middle switch is bridge-connected between the first upper node and a first lower node;
the second upper switch is bridge-connected between the input positive terminal and a second upper node;
the second middle switch is bridge-connected between the second upper node and a second lower node;
wherein the low-voltage switch comprises a first lower switch and a second lower switch;
the first lower switch is bridge-connected between the first lower node and the input negative terminal;
the second lower switch is bridge-connected between the second lower node and the input negative terminal.

26. The power conversion device of claim 25, wherein the low-voltage winding comprises the first low-voltage winding and the second low-voltage winding;
the first end of the first low-voltage winding is electrically connected with the first lower node; the first end of the second low-voltage winding is electrically connected with the second lower node; the second end of the first low-voltage winding and the second end of the second low-voltage winding are electrically connected with the output positive terminal.

27. The power conversion device of claim 26, further comprising:
a first flying capacitor and a second flying capacitor;
wherein the high-voltage winding comprises a first high-voltage winding and a second high-voltage winding; the first end of the first flying capacitor is electrically connected with the first upper node, the second end of the first flying capacitor is electrically connected with the first end of the first high-voltage winding, the second end of the first high-voltage winding is electrically connected with the second lower node;
the first end of the second flying capacitor is electrically connected with the second upper node, the second end of the second flying capacitor is electrically connected with the first end of the second high-voltage winding, the second end of the second high-voltage winding is electrically connected with the first lower node.

28. The power conversion device of claim 25, further comprising:
an input capacitor;
wherein the input capacitor comprises the first input capacitor and the second input capacitor, wherein the first input capacitor is bridge-connected between the input positive terminal and the input negative terminal, and the second input capacitor is bridge-connected between the input positive terminal and the output positive terminal.

29. The power conversion device of claim 25, further comprising:
an output capacitor, wherein the output capacitor is bridge-connected between the output positive terminal and the output negative terminal;
the high-voltage switches and low-voltage switches are disposed on the upper surface of the substrate; the output capacitors are disposed on the lower surface of the substrate, and the output capacitors are arranged in a one-to-one correspondence mode with the low-voltage switches.

30. The power conversion device of claim 29, wherein the input capacitors are arranged adjacent to the high-voltage switch;
the first flying capacitor is arranged adjacent to the first upper switch and/or the first middle switch; the second flying capacitor is arranged adjacent to the second upper switch and/or the second middle switch.

31. The power conversion device of claim 22, further comprising:
the input positive terminal, the input negative terminal, the output positive terminal, and the output negative terminal;
wherein the low-voltage switch comprises four secondary switch bridge arms, each secondary switch bridge arm comprises a middle-node of the secondary bridge arm;
the four secondary switch bridge arms are bridge-connected between the output positive terminal and the output negative terminal;
the low-voltage winding comprises a first low-voltage winding and a second low-voltage winding, the first low-voltage winding is bridge-connected between two middle-nodes of the secondary bridge arms; the second low-voltage winding is bridge-connected between the other two middle-nodes of the secondary bridge arms.

32. The power conversion device of claim 31, wherein the high-voltage switch comprises two primary switch bridge arms;
wherein each primary switch bridge arm comprises a middle-node of the primary switch bridge arm; the two primary switch bridge arms are bridge-connected between the input positive terminal and the input negative terminal;
wherein the power conversion device further comprises a resonant capacitor,
wherein the resonant capacitor and the high-voltage winding are electrically connected and bridge-connected between the two middle-nodes of the primary switch bridge arms.

33. The power conversion device of claim 32, wherein the low-voltage switches are disposed on the upper surface and the lower surface of the substrate; the low-voltage switch on the upper surface and the low-voltage switch on the lower surface are in one-to-one correspondence mode.

34. The power conversion device of claim 33, further comprising:
an input capacitor, an output capacitor, input terminals, and output terminals,
wherein the input capacitor and input terminals are disposed adjacent to the high-voltage switch; the output capacitor and the output terminals are disposed adjacent to the low-voltage switch.

35. A start-up device for a power conversion device, wherein the power conversion device comprises an input positive terminal, an input negative terminal, an output positive terminal, an output negative terminal, a plurality of switches, and magnetic assembly; wherein the magnetic assembly comprises a magnetic core and a winding;
wherein the start-up device comprises an auxiliary power supply circuit, and the auxiliary power supply circuit comprises an input capacitor, an LDO circuit, an input circuit, a step-down circuit, a first auxiliary output voltage, and an auxiliary output capacitor;
the first auxiliary output voltage is a voltage between an auxiliary output positive terminal and an input negative terminal; the LDO circuit is electrically connected with the input positive terminal, the input negative terminal and the step-down circuit; the input circuit, the step-down circuit and the LDO circuit are electrically connected with the auxiliary input connection point;
wherein the input circuit comprises an auxiliary input winding, and the auxiliary input winding is coupled with a winding of the magnetic assembly; and the first auxiliary output voltage is the output voltage of the step-down circuit;
wherein when the power conversion device is started, the step-down circuit receives power supply from the LDO, and the first auxiliary output voltage is established; and
wherein when the power conversion device enters a steady state, the input circuit supplies power to the first auxiliary output voltage through the step-down circuit.

36. The start-up device of claim 35, wherein the input circuit comprises an auxiliary input diode;
a positive electrode of the auxiliary input diode is electrically connected to a first end of the auxiliary winding, a negative electrode of the auxiliary input diode is electrically connected to an auxiliary input connection point;
a second end of the auxiliary winding is electrically connected the input negative terminal.

37. The start-up device of claim 35, wherein the step-down circuit comprises an auxiliary bridge arm, an auxiliary step-down capacitor, a first auxiliary output winding, a second auxiliary output winding, and an auxiliary output diode;
the auxiliary bridge arm is bridge-connected between the auxiliary input connection point and the input negative terminal, and comprises an upper switch and a lower switch;
the upper switch and the lower switch are electrically connected with the middle-point of the auxiliary bridge arm; the auxiliary step-down capacitor, the first auxiliary output winding and the second auxiliary output winding are electrically connected in sequence, and bridge-connected between the middle-point of the auxiliary bridge arm and the first auxiliary output voltage;
the first auxiliary output winding and the second auxiliary output winding are wound around a same magnetic core;
a positive electrode of the auxiliary diode is electrically connected with the input negative terminal, the negative electrode of the auxiliary diode is electrically connected with a connection point of the two auxiliary output windings.

38. The start-up device of claim 37, further comprising:
a second auxiliary output circuit, wherein the second auxiliary output circuit comprises a switch and a third auxiliary output winding;
the third auxiliary output winding, the first auxiliary output winding, and the second auxiliary output winding are wound in a same magnetic core.
